(19) United States
(12) Patent Application Publication
(10) Pub. No.: US 2025/0005512 A1
(43) Pub. Date: Jan. 2, 2025

(54) DYNAMIC HOSPITALITY INVENTORY MANAGEMENT

(71) Applicant: Laundris Corporation, Austin, TX (US)

(72) Inventors: Donald Ward, Austin, TX (US); Edward Casteel Milner, Dallas, TX (US); Joseph M. Dominguez, Austin, TX (US)

(73) Assignee: Laundris Corporation, Austin, TX (US)

(21) Appl. No.: 18/692,750

(22) PCT Filed: Sep. 19, 2022
(86) PCT No.: PCT/US2022/076658

§ 371 Date: Mar. 15, 2024

Related U.S. Application Data
(60) Provisional application No. 63/261,310, filed on Sep. 17, 2021.

(51) Int. Cl. G06Q 10/087; G06Q 10/02

(52) U.S. Cl. CPC G06Q 10/087; G06Q 10/02

(57) ABSTRACT

Apparatus and associated methods relate to dynamically manage inventory of a hospitality property. In an illustrative example, a property management system (PMS) may be configured to store a digital inventory of a hospitality property. The PMS, for example, may generate a historical future booking data (HFBD) of the hospitality property based on near future booking data and correlated attributes including season of a year, environmental attributes, and booking attributes. For example, the PMS may apply a machine learning model to generate a predicted inventory usage based on the HFBD. The PMS may, for example, generate a supply data based on real-time tracking of new inventory from vendors and restored inventory of reusable inventory (e.g., linens) from process centers. For example, an acquisition signal to acquire additional inventory may be generated. Various embodiments may advantageously manage hospitality inventory automatically and dynamically managed in real-time to reduce surplus inventory.

### CROSS-REFERENCE TO RELATED APPLICATIONS

This application claims the benefit of U.S. Provisional Application Ser. No. 63/261,310, titled “Dynamic Hospitality Inventory Management,” filed by Donald Ward, et al., on Sep. 17, 2021.

This application incorporates the entire contents of the foregoing application(s) herein by reference.

The subject matter of this application may have common inventorship with and/or may be related to the subject matter of the following: U.S. Application Ser. No. 62/802,079, titled “IoT-Enabled Article Asset Tracking with API Integration,” filed by Donald Ward on Feb. 6, 2019; U.S. application Ser. No. 16/783,416, titled “Inventory Management System,” filed by Donald Ward, et al., on Feb. 6, 2020, and issued as U.S. Pat. No. 11,004,034 on May 11, 2021; and U.S. application Ser. No. 17/212,908, titled “Inventory Management System,” filed by Donald Ward, et al., on Mar. 25, 2021.

This application incorporates the entire contents of the foregoing application(s) herein by reference.

### TECHNICAL FIELD

Various embodiments relate generally to inventory management

### BACKGROUND

Inventory management plays an important role in many places. For example, for a restaurant, different amounts of different fruits, vegetables, and meats may be decided based on the restaurant manager's estimated sales volume of different products (e.g., different dishes). For the healthcare supply industry, the need of the medicine may vary based on, for example, the location of a pharmacy (e.g., a pharmacy located in northwest of America vs. a pharmacy located in southeast of America), the weather and the season (e.g., summer vs. winter), and/or the size of the pharmacy.

If products (e.g., medicine) sell well, such products may run out of stock due to improper inventory management. The above condition may then directly affect the sales volume of the products, and the profits of the business will decrease. On the contrary, if the products sell poorly, such products may be stocked up due to improper inventory management. Such a condition may affect, for example, cash flow management of the business, such that the operation of the business will be poor.

US Patent Application Publication Serial No. 2021/233017 A1 filed by Donald Ward et al. discloses an inventory management system having a machine learning engine trained to dynamically predict a demand amount of the inventory in response to a set of near-future data. US Patent Application Publication Serial No. 2020/143313 A1 filed by Henrik Ohlsson et al. discloses a system and method for tracking re-usable textile inventory movement and determining the optimal target fraction for each inventory item. US Patent Application Publication Serial No. 2020/0577979 A1 filed by Craig E Milum discloses a method of applying machine learning to accurately manage and predict inventory variables with future uncertainty. US Patent Application Publication Serial No. 2019/172012 A1 filed by Cayce Roy et al. discloses a healthcare supply chain management system based on extracted schedules and procedure information from electronic health record systems.

### SUMMARY

Apparatus and associated methods relate to dynamically manage inventory of a hospitality property. In an illustrative example, a property management system (PMS) may be configured to store a digital inventory of a hospitality property. The PMS, for example, may generate a historical future booking data (HFBD) of the hospitality property based on near future booking data and correlated attributes including season of a year, environmental attributes, and booking attributes. For example, the PMS may apply a machine learning model to generate a predicted inventory usage based on the HFBD. The PMS may, for example, generate a supply data based on real-time tracking of new inventory from vendors and restored inventory of reusable inventory (e.g., linens) from process centers. For example, an acquisition signal to acquire additional inventory may be generated. Various embodiments may advantageously manage hospitality inventory automatically and dynamically managed in real-time to reduce surplus inventory.

Various embodiments may achieve one or more advantages. For example, some embodiments may provide a property management system that may advantageously generate and/or apply machine learning models to generate acquisition signals as a function of received data. Various embodiments may advantageously (e.g., automatically) monitor and/or manage (e.g., acquire) inventory to maintain inventory preferences. The inventory may, for example, advantageously be managed in response to near future data (e.g., near future room booking data). The property management system may, for example, advantageously dynamically manage inventory as a function of various input variables (e.g., based on predetermined preferences and/or criteria).

Various embodiments may, by way of example and not limitation, advantageously manage (e.g., acquire, restore) inventory through restoration and/or acquisition channels. Various embodiments may, for example, advantageously suggest, initiate, and/or manage operations (e.g., preventative maintenance) related to restorable inventory.

Various embodiments may, for example, advantageously enable improvements in management of inventory at various stages. For example, sufficient linen items may be available in spite of events and/or conditions which a human may not be able to predict. For example, various embodiments may advantageously provide a technical solution to property managers attempting to guess inventory usage based on memory and/or instinct. Various embodiments may, for example, provide a technical solution to facilities maintaining fluctuating par levels because of human managers guessing at future usage based on past memory and/or because of limited time to review records. Various embodiments may, by way of example and not limitation, advantageously provide a technical solution to properties providing substandard service due to human managers calculating inventory usage. An automatic system for dynamically maintaining a level of inventory sufficient to achieve service goals may, for example, advantageously reduce cost spent on unused inventory (e.g., linens, expired food).

The details of various embodiments are set forth in the accompanying drawings and the description below. Other features and advantages will be apparent from the description and drawings, and from the claims.

### BRIEF DESCRIPTION OF THE DRAWINGS

FIG. 1 depicts an exemplary property management system employed in an illustrative use-case scenario.

FIG. 2 depicts a block diagram of an exemplary property management system having an exemplary inventory management system.

FIG. 3 depicts a block diagram of an exemplary machine learning engine implemented in the exemplary inventory management system.

FIG. 4 depicts a flowchart of an exemplary method of managing inventory.

FIG. 5 depicts an exemplary inventory model.

FIG. 6 depicts a flowchart of an exemplary method of training at least one of the inventory models.

FIG. 7 depicts a flowchart of an exemplary method of generating an inventory usage prediction.

FIG. 8 depicts a flowchart of an exemplary method of applying an inventory model(s) to generate an acquisition signal(s).

FIG. 9 depicts a flowchart of an exemplary method of applying an inventory model(s) to (automatically) distribute projected surplus across a network.

FIG. 10 depicts a flowchart of an exemplary method of applying an inventory model(s) to (automatically) provision a (new) property.

Like reference symbols in the various drawings indicate like elements.

### DETAILED DESCRIPTION OF ILLUSTRATIVE EMBODIMENTS

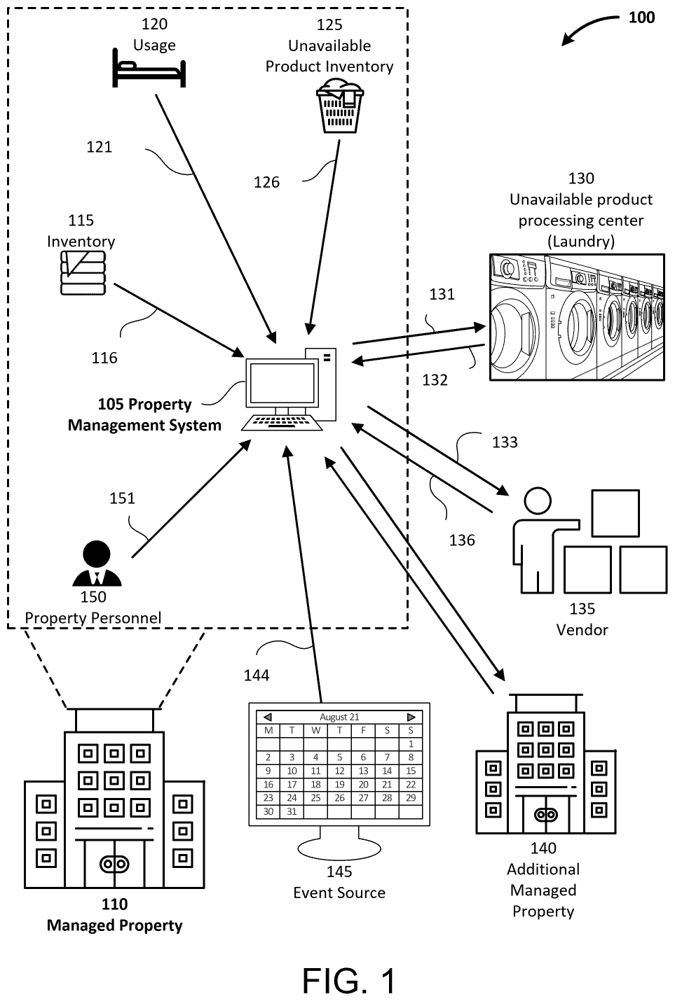

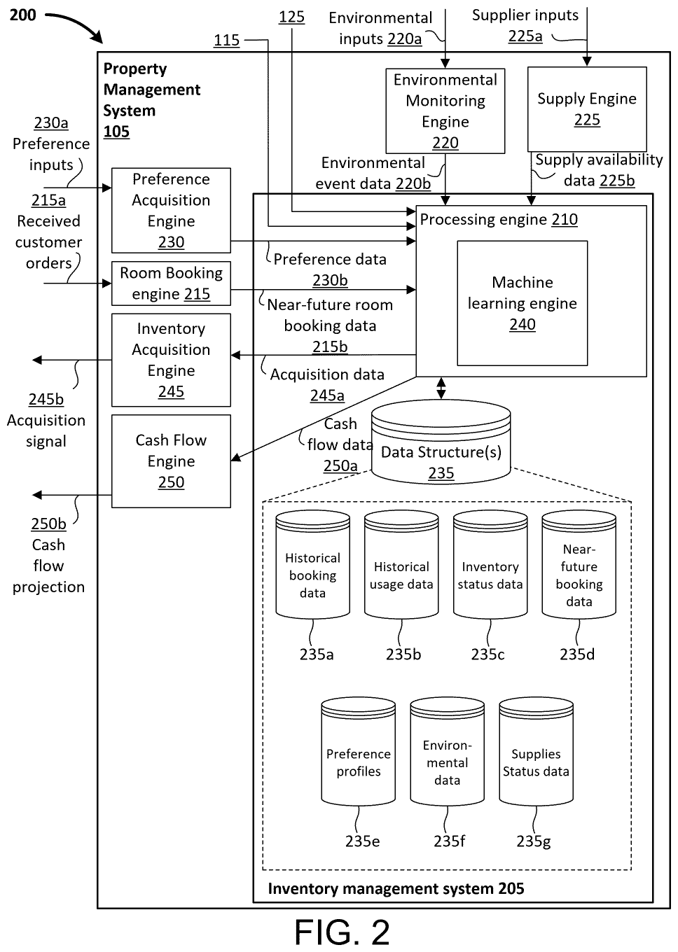

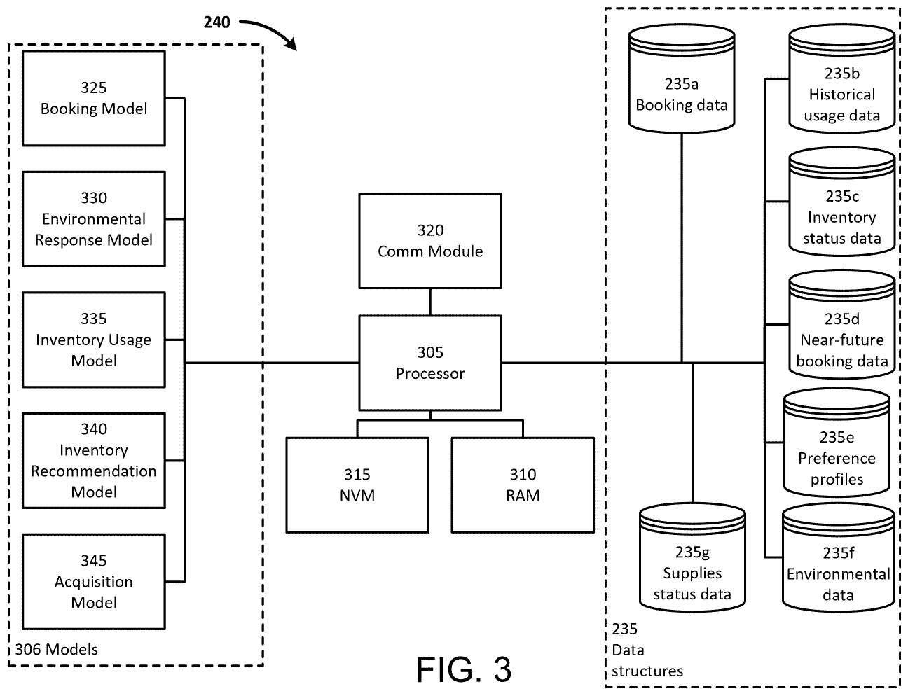

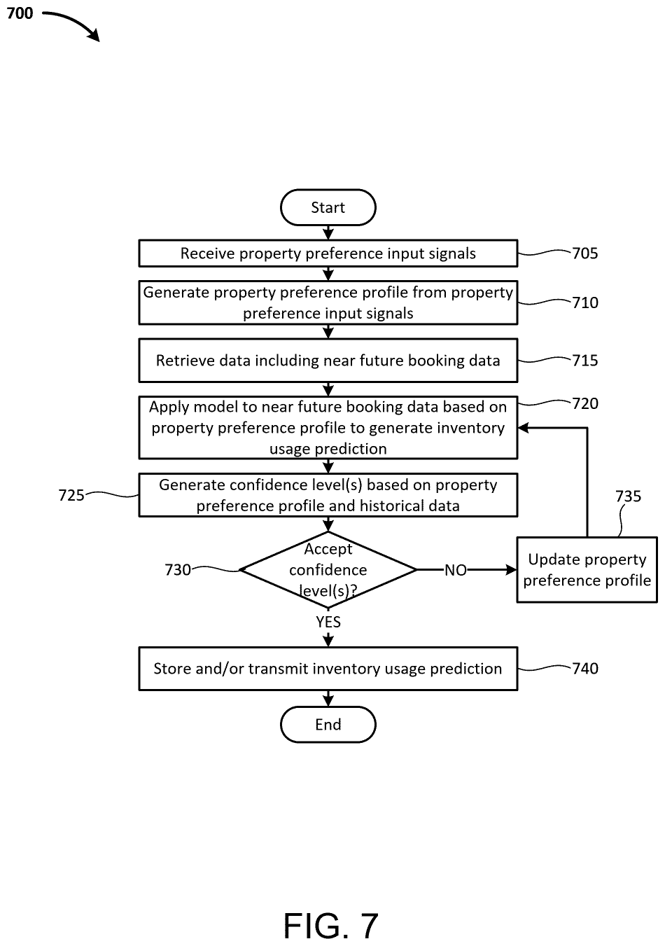

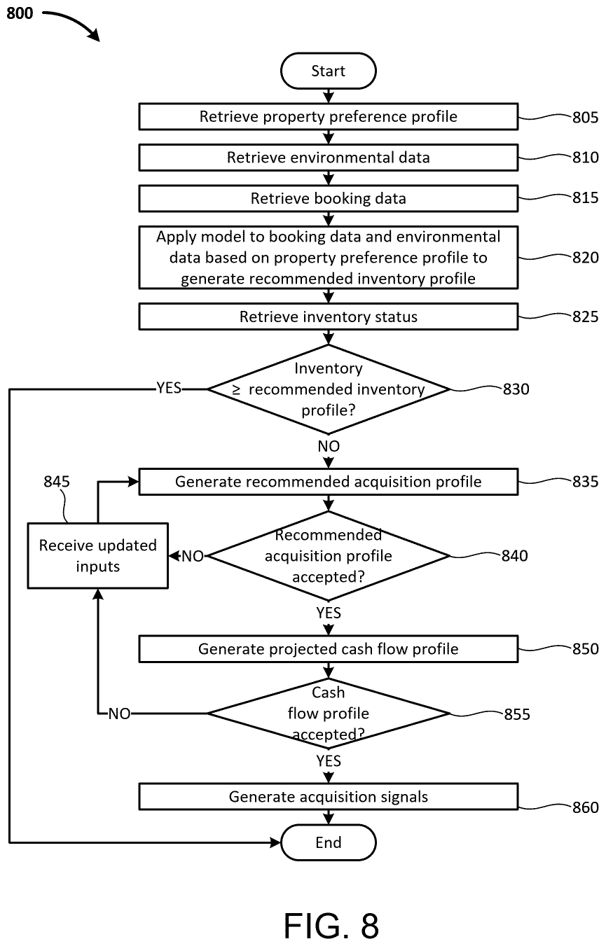

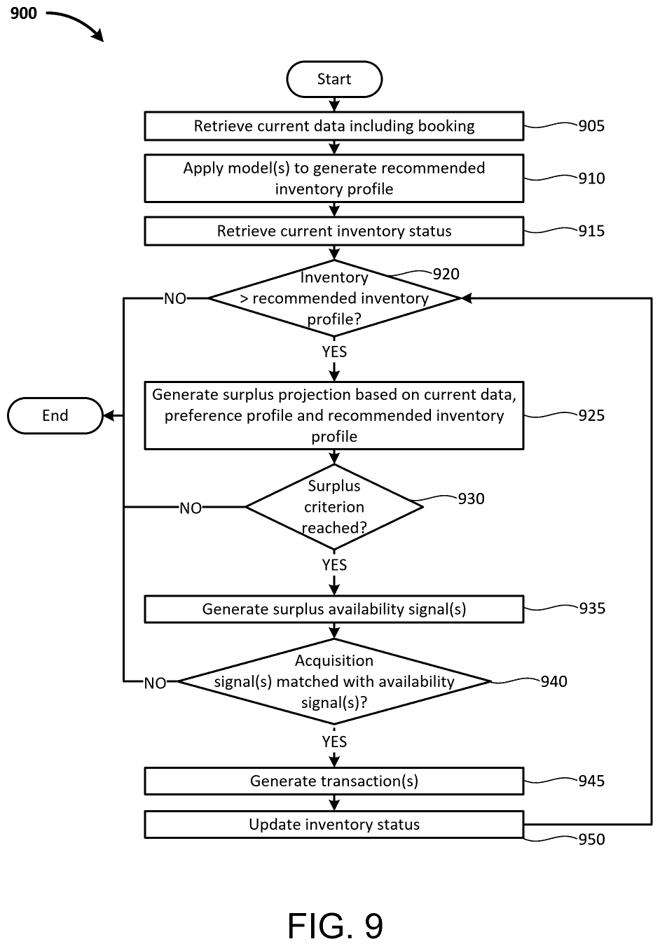

To aid understanding, this document is organized as follows. First, to help introduce discussion of various embodiments, an exemplary property management system is introduced with reference to FIGS. 1-2. Second, that introduction leads into a description with reference to FIGS. 3-6 of some exemplary embodiments of inventory models which may be employed in the exemplary property management system. Third, with reference to FIG. 7, inventory management embodiments are described in application to generating inventory usage prediction as a function of property preferences. Fourth, with reference to FIG. 8, the discussion turns to exemplary embodiments in application to generating inventor acquisition signals. Fifth, and with reference to FIG. 9, this document describes exemplary embodiments which may be applied to balancing surplus inventory across a network. Finally, the document discusses further embodiments, exemplary applications and aspects relating to property management systems.

FIG. 1 depicts an exemplary property management system employed in an illustrative use-case scenario. Inventory management may serve an important role in many places. In this depicted scenario 100, an exemplary property management system 105 is employed by a managed property 110. The managed property 110 may, for example, include a hotel. The property management system 105 manages inventory 115 of the managed property 110. The property management system 105 may, for example, maintain a digital twin of at least some aspects of the managed property 110.

The inventory 115 may include assets of a hotel. Managed assets may, for example, include disposables (e.g., soap, paper) of the hotel. Managed assets may include, by way of example and not limitation, perishables (e.g., food). Managed assets may, for example, include durable goods. In some embodiments managed assets may include, for example, linens (e.g., towels, washcloths, pillowcases, sheets, quilts, blankets, rugs). In some embodiments managed assets may, for example, include labor (e.g., staff availability). In some embodiments managed assets may, for example, include service capabilities (e.g., room capacity, laundry cleaning capacity).

The property management system 105 may track an inventory status 116 (e.g., categories, amounts of linens) of inventory 115 and automatically generate acquisition and/or dispersal signals in response to current and/or historical data. For example, the property management system 105 may generate signals as a function of asset usage data 120. The asset usage data 120 may, for example, include room booking information 121. The asset usage data 120 may, for example, include near future room booking information 121 (e.g., one-week, two-week, one-month).

By way of example, embodiments of tracking the inventory status 116 is described, with reference to [001]-[005] of the U.S. Provisional Application Ser. No. 62/802,079, titled “IoT-Enabled Article Asset Tracking with API” and filed by Donald Ward on Feb. 6, 2019; U.S. application Ser. No. 16/783,416, titled “Inventory Management System,” filed by Donald Ward, et al., on Feb. 6, 2020, and issued as U.S. Pat. No. 11,004,034 on May 11, 2021; and U.S. application Ser. No. 17/212,908, titled “Inventory Management System,” filed by Donald Ward, et al., on Mar. 25, 2021, the entire contents of which applications are incorporated herein by reference.

By using the property management system 105, the managed property 110 may achieve improved (e.g., optimized) management of the inventory 115 (e.g., linen) at various stages of use. For example, sufficient linen items may be maintained available in spite of fluctuations in asset usage data 120. Linens in an inventory storage closet or alcove may become, for example, damp and/or moldy after a period of time. For example, the hotel may not use those damp and/or moldy linens. Various embodiments may, for example, advantageously maintain a proper amount of inventory (e.g., by acquisition and/or dispersal) in response to inventory usage predictions by the property management system 105. Accordingly, for example, the managed property 110 may advantageously reduce costs of unused products (e.g., damp and/or moldy linens, expired foods).

In this depicted scenario 100, the property management system 105 may, for example, be configured to monitor multiple locations and/or asset (classes) of the managed property 110. Categories and/or amounts of the inventory 115 may, for example, be recorded and dynamically updated in the property management system 105. The asset usage data 120 (e.g., room booking and/or occupancy data) may be monitored by the property management system 105. In this depicted example, some of the inventory 115 may be withdrawn from availability as an unavailable product inventory 125. For example, reusable linens may be used (e.g., soiled), and so be withdrawn into the unavailable product inventory 125. An unavailable product information 126 may be sent to a processing center 130. For example, used linens may be sent to a laundry center for laundering. The property management system 105 may, for example, receive capacity information from one or more of the processing center 130. The property management system 105 may, for example, generate acquisition signal(s) 131 (e.g., request for laundering services) based on the capacity information 132 (e.g., available laundering capacity, lead time).

The property management system 105 may generate one or more acquisition signals in response to determining that the inventory 115 is (predicted to be) below one or more inventory criteria. For example, a predetermined set of inventory criteria may include a par level. The par level may, for example, define inventory level(s) as a function of predicted usage (e.g., asset usage data 120 such as near future room booking data). The property management system 105 may, for example, generate a predicted inventory usage (e.g., as a function of the asset usage data 120 such as near future room booking data). The property management system 105 may generate at least one acquisition signal as a function of the predicted inventory usage and the inventory criteria (e.g., par level), such as if the inventory 115 is predicted to not meet the predicted inventory usage according to the par levels. The prediction(s) may, for example, be generated by a processing engine (e.g., of the property management system 105). An exemplary architecture of the processing engine is discussed in detail with reference at least to FIG. 2.

Periodic automatic replacement (“PAR”) level(s) may, for example, be implemented in various embodiments as a tool for effective inventory management. PAR may be used to determine a minimum level of inventory a property intends to maintain on hand for a given period of time. For example, in various embodiments, par level may correspond to a multiple of inventory for an item(s) required to fully stock a unit of a property. In an illustrative example, a property (e.g., a hotel) may plan to equip each room with 4 towels. The property may, for example, have 100 rooms. Accordingly, in the illustrative example, 400 towels would be required to stock the rooms. A par level of 4 (for towels) would then be, for example, 1600 towels. Such an inventory reserve above that required to stock the room(s) allows for a certain portion of inventory to be in process (e.g., at a laundry facility, in storage).

The property management system 105 may, for example, transmit acquisition signal(s) 133 to a vendor 135. The property management system 105 may, for example, receive stock information 136 (e.g., stock quantity, pricing, shipping times) from the vendor 135. The property management system 105 may, for example, generate and/or transmit acquisition signal(s) to various vendors 135 based on the stock information 136 received.

In some embodiments the property management system 105 may manage additional properties. An additional property 140 is managed in the depicted example. The additional property 140 may, for example, be another hotel. The additional property 140 may, for example, include another type of property (e.g., restaurant, entertainment facility). The additional property 140 may, for example, be located on the same real estate (e.g., in a same building, on a same lot). The additional property 140 may be located on adjacent real estate, for example (e.g., neighboring lot). The additional property 140 may, for example, be located in the same region (e.g., neighborhood, downtown, city, county, state). The additional property 140 may, for example, be geographically distant (e.g., another county, another state, another country).

The property management system 105 may, for example, be configured to receive, generate, and/or transmit inventory data (e.g., such as regarding inventory 115 for the managed property 110 and/or the additional property 140) between the property management system 105 and the additional property 140. For example, the property management system 105 may predict a need for additional inventory for the managed property 110. The property management system 105 may, for example, predict surplus of the same (type of) inventory for the additional property 140. The property management system 105 may, for example, generate an acquisition signal(s) and/or dispersal signal(s) to initiate transfer of (at least some of) the surplus inventory from the additional property 140 to the managed property 110. Accordingly, inventory may advantageously be balanced across a network of managed properties by the property management system 105.

In some embodiments the property management system 105 may, for example, communicate with a network of property management systems (e.g., via peer-to-peer, central server, application programming interface (API)). The inventory predictions may, for example, be generated by different property management systems. In some embodiments property management systems may publish (e.g., broadcast, transmit upon request, post to at least one known location) surplus inventory for one or more managed properties. Another property management system may generate acquisition signal(s) based on a prediction of a need for inventory for corresponding managed property (e.g., based on the surplus information).

In various embodiments, such as in the depicted example, the property management system 105 may receive environmental information 144 from at least one event source 145. Environmental information may, for example, include (predicted) weather conditions (e.g., a hotel may plan for increased linen usage in response to a major freezing event). Environmental information may, for example, include upcoming (planned) events (e.g., a hotel near a large event center may plan for increased linen usage in response to more events and/or larger predicted attendance). Environmental information may, for example, include current and/or predicted events in other areas (e.g., a hotel in Austin may retrieve information regarding a hurricane in Houston, a five-star restaurant in Hermann, MO may retrieve information regarding a business event in St. Louis likely to attract high profile visitors). In some embodiments environmental information may, for example, include regulatory and/or economic data (e.g., upcoming changes to regulations which may affect availability of items, predicted shortages and/or price changes in inventory). Environmental information may, for example, include predetermined and/or cyclical schedules (e.g., restaurants in college towns may plan for decreased inventory usage during school breaks). Environmental information may, for example, include social networking data (e.g., public messages regarding intended travel). The at least one event source 145 may, for example, include a (publicly available) calendar. The at least one event source 145 may include, by way of example and not limitation, a weather forecasting service. The at least one event source 145 may include, in some embodiments, a travel service. The at least one event source 145 may, for example, include an aggregation service. In various embodiments the property management system 105 may, for example, generate inventory usage predictions and/or acquisition signal(s) as a function of the environmental information from the at least one event source 145.

In some embodiments, environmental information may be implicitly obtained. For example, the property management system 105 may generate implicit environmental data based on historical hotel occupancy forecast. For example, the property management system 105 may include a machine learning algorithm with random forest learning to determine relevant correlations in the environmental information associated with historical hotel occupancy forecast with linen usage, for example.

In some embodiments, such as in the depicted example, the property management system 105 may receive preference information 151 from property personnel 150. The property personnel 150 may, for example, include management of the managed property 110. The preference information 151 may, for example, include preferences for the specific managed property 110. The preference information 151 may, for example, include (general) preferences applicable to multiple properties (e.g., company-wide policies). In some embodiments preference information 151 may, for example, include preferred par levels. In some embodiments the preference information 151 may, for example, include preferred confidence levels in inventory usage predictions. The preference information 151 may, for example, include preferences (e.g., service level preferences, cost preferences) which may correspond to inventory preferences. In various embodiments the property management system 105 may generate inventory usage predictions and/or acquisition signals as a function of the preference information 151.

FIG. 2 depicts a block diagram of an exemplary property management system having an exemplary inventory management system. In a depicted example 200, the property management system 105 includes an inventory management system 205. The inventory management system 205 may, for example, be configured to monitor the inventory 115. The inventory management system 205 may generate a prediction(s) of inventory (e.g., quantity, type) to be used in the (near) future. The inventory management system 205 includes a processing engine 210. The processing engine may, for example, be embodied using at least one processor, random-access memory module(s), and/or non-volatile memory module(s), such as disclosed at least with reference to FIG. 3.

The processing engine 210 may, for example, include at least one communication module (not shown) configured to receive and/or transmit data between the processing engine 210 and associated (e.g., local, remote) modules and/or systems. As depicted, the processing engine 210 receives signals relating to the inventory 115. The processing engine 210 receives signals relating to the unavailable product inventory 125. For example, the processing engine 210 may operate on the signals corresponding to the inventory 115 and/or the unavailable product inventory 125 to determine a current inventory status.

The processing engine 210 is in operable communication with a room booking engine 215. The room booking engine 215 receives customer order signals 215a (labeled “received customer orders”). The customer order signals 215a may, for example, relate to the asset usage data 120 (e.g., represent planned usage of rooms, beds). The room booking engine 215 may operate on the customer order signal 215a to generate near future room booking data 215b. The near future room booking data 215b may, for example, be generated according to a (predetermined) time window relative to a present time (e.g., 1 week, 2 weeks, 3 weeks, 1 month, 3 months). The time window may, for example, be (dynamically) determined relative to a (predicted) ordering lead time. For example, a near future time window (e.g., absolute, relative to at least one specific product) may be automatically determined in response to an expected lead time for a particular product and/or class of products.

The processing engine 210 is in operable communication with an environmental monitoring engine 220. The environmental monitoring engine 220 receives environmental input signals 220a. The environmental input signals 220a may, for example, be received from the at least one event source 145. The environmental monitoring engine 220 may operate on the environmental input signals 220a to generate environmental event data 220b.

The processing engine 210 is in operable communication with a supply engine 225. The supply engine 225 receives supplier input signals 225a. The supply engine 225 operates on the supplier input signals 225a to generate supply availability data 225b. The supplier input signals 225a may, for example, be received from the vendor 135. For example, the supplier input signals 225a may correspond to stock data for the vendor 135. The stock data may, for example, correspond to products in the inventory 115. The stock data may, for example, be received from the vendor 135 in response to a signal generated by the processing engine 210 (e.g., an acquisition signal, an information request signal). The supplier input signals 225a may, for example, be received from the processing center 130. For example, the supplier input signals 225a may correspond to capacity information from one or more of the processing center 130.

In some embodiments the supplier input signals 225a may, for example, be received from an additional property 140. In such embodiments the supplier input signals 225a may correspond, by way of example and not limitation, to surplus inventory data. The surplus inventory data may, for example, correspond to at least one product in the inventory 115.

The processing engine 210 is in operable communication with a preference acquisition engine 230. The preference acquisition engine 230 receives preference input signals 230a. The preference input signals 230a may, for example, be received from the property personnel 150. The preference acquisition engine 230 may operate on the preference input signals 230a to generate preference data 230b. The preference input signals 230a may, for example, correspond to environmental data criteria (e.g., applied by the environmental monitoring engine 220 and/or the processing engine 210). The preference input signals 230a may, for example, correspond to inventory criteria (e.g., inventory threshold, par level, acceptable confidence levels, service levels). The preference input signals 230a may, for example, correspond to room booking data criteria (e.g., defining a near future window(s)). The preference input signals 230a may, for example, correspond to cash flow preferences. The preference input signals 230a may, for example, correspond to acquisition preferences (e.g., preferred suppliers).

The processing engine 210 is operably coupled to a data structure 235. The data structure 235 may, for example, include one or more data storage devices. The data structure 235 may, for example, include one or more data stores. The data structure 235 may, for example, include one or more sub data structures. The data structure 235 may, by way of example and not limitation, be local, remote, distributed (e.g., redundant, peer-to-peer), or some combination thereof. In some embodiments the data structure 235 may include non-volatile memory module(s).

In the depicted example the data structure 235 includes historical booking data 235a. The historical booking data 235a data store may include historical near future room booking data 215b (e.g., after processing, retrieved from other sources). The historical booking data 235a may, for example, include historical occupancy data. The historical booking data 235a may include historical booking data. The historical booking data 235a may, for example, include historical near future booking data. The historical booking data 235a may, for example, include historical values of the asset usage data 120.

The data structure 235 includes historical usage data 235b. The historical usage data 235b may, for example, include historical use of the inventory 115 and/or historical values of the unavailable product inventory 125. The historical usage data 235b may, for example, include historical inventory status data (e.g., such as including and/or corresponding to historical inventory 115 data and/or historical unavailable product inventory 125 data).

The data structure 235 includes inventory status data 235c. The inventory status data 235c may, for example, include data corresponding to the inventory 115 and/or the supply engine 225.

The data structure 235 includes near future booking data 235d. The near future booking data 235d datastore may, for example, store the near future room booking data 215b. The data structure 235 includes preference profiles 235e. The preference profiles 235e datastore may, for example, store the preference data 230b. The data structure 235 includes environmental data 235f. The environmental data 235f datastore may store, for example, the environmental event data 220b. The data structure 235 includes supplies status 235g. The supplies status 235g datastore may store, for example, the supply availability data 225b.

The processing engine 210 includes a machine learning engine 240. In some embodiments the processing engine 210 may, for example, include and/or be in operable communication with multiple machine learning engines (e.g., the machine learning engine 240 may include multiple machine learning engines). The machine learning engine 240 may, for example, generate, train, and/or apply one or more machine learning models using received data (e.g., near future room booking data 215b, environmental event data 220b, supply availability data 225b, preference data 230b). The machine learning engine 240 may, for example, generate, train, and/or apply one or more machine learning models using (retrieved) stored data (e.g., from the data structure 235). The machine learning engine 240 may, for example, be configured to generate one or more predictions and/or suggestions in response to the received and/or stored data. The machine learning engine 240 may, for example, generate inventory usage predictions. The machine learning engine 240 may, for example, generate acquisition suggestions. The machine learning engine 240 may, for example, generate cash flow predictions. In some embodiments the processing engine 210 may, for example, process, operate on, store, and/or transmit outputs of the machine learning engine 240.

In the depicted example, acquisition data 245a is transmitted from the processing engine 210 to an inventory acquisition engine 245. The machine learning engine 240 may, for example, generate the acquisition data 245a in response to the near future room booking data 215b. The acquisition data 245a may be generated, for example, in response to various data and/or signals depicted in FIG. 2. The acquisition data 245a may, for example, correspond to one or more suggested acquisitions of inventory. The inventory acquisition engine 245 may, for example, generate one or more interfaces displaying suggested acquisitions to one or more users (e.g., property manager, company manager, (potential) vendor). The inventory acquisition engine 245 may operate on the acquisition data 245a (e.g., as modified by input from users such as in response to the interfaces generated) to generate acquisition signals 245b (e.g., corresponding to order(s) for more inventory).

In the depicted example, (predicted) cash flow data 250a is transmitted to a cash flow engine 250. The cash flow engine 250 may operate on the cash flow data 250a to generate cash flow projection signals 250b. The cash flow projection signals 250b may, for example, correspond to cash flow projections provided to one or more personnel (e.g., property manager, accountant, company manager). The cash flow projection signals 250b may, for example, be applied to generate one or more interfaces displaying the projected cash flow to a user(s). The cash flow data 250a may, for example, be generated by the machine learning engine 240 in response to the near future room booking data 215b. The cash flow data 250a may, for example, be generated in response to various signals and/or data depicted in FIG. 2. In some embodiments, responses to the cash flow projection(s) may, for example, be received. The processing engine 210 (e.g., using the machine learning engine 240) may generate the acquisition data 245a as a function of the responses received.

Accordingly, in various embodiments the property management system 105 may advantageously apply machine learning models to generate acquisition signals as a function of received data. Various embodiments may advantageously (automatically) monitor and/or manage inventory to maintain inventory preferences. The inventory may, for example, be managed in response to near future room booking data. The near future room booking data may, for example, be compared to historical data (e.g., historical near future room booking data and/or historical occupancy data). The property management system 105 may, for example, advantageously dynamically manage inventory as a function of various input variables (e.g., based on predetermined preferences and/or criteria). Various operations which may be performed by the inventory management system 205 are disclosed at least with reference to FIGS. 3-10.

By using the inventory management system 205, the managed property 110 may, for example, achieve improvements in management of inventory at various stages. For example, sufficient linen items may be available in spite of events and/or conditions which a human may not be able to predict. For example, various embodiments may advantageously provide a technical solution to property managers attempting to guess linen usage based on memory and/or instinct. Various embodiments may, for example, provide a technical solution to hotels maintaining fluctuating par levels because of human managers guessing at future usage based on past memory and/or because of limited time to review records. Various embodiments may provide a technical solution to properties providing substandard service due to human managers calculating inventory usage. An automatic system for dynamically maintaining a level of inventory sufficient to achieve service goals may, for example, advantageously reduce cost spent on unused products (e.g., linens, expired food).

FIG. 3 depicts a block diagram of an exemplary machine learning engine implemented in the exemplary inventory management system. In the depicted example, the machine learning engine 240 includes a processor 305. The processor 305 may, for example, include one or more processors. The processor 305 is in operable communication with one or more random-access memory modules (RAM 310). The processor 305 is in operable communication with one or more non-volatile memory modules (NVM 315). The processor 305 is in operable communication with a communication module 320. The communication module 320 may, for example, include one or more communication circuits, software, and/or hardware. The communication module 320 May for example, include wireless communication (e.g., near-field, long distance). The communication module 320 may, for example, include wired communication (e.g., local, remote). The communication module 320 may, for example, include extract-transform-load modules. The communication module 320 may be operably coupled to one or more engines (e.g., as depicted in FIG. 3). The communication module 320 may be configured to communicate with one or more engines. In some embodiments the machine learning engine 240 may be integral to the processing engine 210 (e.g., the machine learning engine 240 depicted in this FIG. 3 may also be configured as the processing engine 210).

The processor 305 is in operable communication with the data structure 235. The data structure 235. The processor 305 is in operable communication with one or more models 306. In some embodiments the models 306 may, for example, include one or more programs of instructions configured to be executed on the processor 305. The one or more models 306 may, for example, be stored on at least one NVM module.

In the depicted example the one or more models 306 includes a booking model 325. The booking model 325 may, for example, be generated from, be trained using, and/or be configured to operate on one or more of the historical booking data 235a, the historical usage data 235b, and the near future booking data 235d. For example, the booking model 325 may generate booking predictions as a function of historical (near future) booking data and current (near future) booking data. The booking model 325 may, for example, be configured to generate booking predictions as a function of the historical booking data, the current booking data, and historical occupancy data corresponding to the historical booking data (e.g., historical near future booking data). For example, the booking model 325 may be configured to generate a prediction of future occupancy as a function of the near future booking data 235d based on historical occupancy corresponding to historical near future booking data 235d. The historical data may, for example, be selected to correspond to specific attributes (e.g., environmental, seasonal).

The one or more models 306 includes, in the depicted example, an environmental response model 330. The environmental response model may, for example, be generated from, be trained using, and/or be configured to operate on the environmental data 235f (e.g., current and/or historical environmental data). The environmental response model 330 may, for example, generate a predicted response (e.g., in booking, in inventory usage) as a function of current and/or historical environmental data. In some embodiments an output of the environmental response model 330 may, for example, be provided to the booking model 325. The booking model 325 may, for example, generate predicted booking data (e.g., including predicted occupancy data) as a function of the output of the environmental response model 330.

The one or more models 306 includes, in the depicted example, an inventory usage model 335. The inventory usage model 335 may, for example, be generated from, be trained using, and/or be configured to operate on the inventory status data 235c. The inventory usage model 335 may, for example, generate a predicted inventory usage as a function of the inventory status data 235c. Output (e.g., predicted inventory usage) of the inventory usage model 335 may be provided to an inventory recommendation model 340. The inventory usage model 335 may, for example, receive an output of the booking model 325. For example, the inventory usage model 335 may generate a predicted inventory usage as a function of at least one output of the booking model 325. The inventory usage model 335 may, for example, receive an output of the environmental response model 330. The inventory usage model 335 may, for example, generate a predicted inventory usage as a function of at least one output of the environmental response model 330.

The one or more models 306 includes, in the depicted example, an inventory recommendation model 340. The inventory recommendation model 340 may, for example, be generated from, be trained using, and/or be configured to operate on the preference profiles 235e, the historical usage data 235b, and/or the outputs of the inventory usage model 335. The inventory recommendation model 340 may generate suggested inventory (e.g., a level of suggested inventory) as a function of historical usage data and preference data. The inventory recommendation model 340 may, for example, generate suggested inventory as a function of predicting booking data (e.g., from the booking model 325). The predicted booking data may, for example, include predicted occupancy data. The inventory recommendation model 340 may, for example, generate suggested inventory as a function of an output of the environmental response model 330.

The one or more models 306 includes, in the depicted example, an acquisition model 345. The acquisition model 345 may, for example, be generated from, be trained using, and/or be configured to operate on output(s) of the inventory recommendation model 340, and/or the supplies status 235g. For example, the acquisition model 345 may generate acquisition suggestions (e.g., suggested purchases and/or leases) as a function of output of suggested inventory from the inventory recommendation model 340. The acquisition model 345 may, for example, generate acquisition suggestions as a function of supplier availability. The acquisition model 345 may generate, for example, acquisition suggestions as a function of the preference profiles 235e.

In various embodiments the one or more models 306 may be advantageously applied to data in the data structure 235 by the processor 305 in order to generate one or more automatic predictions. For example, the machine learning engine 240 may be advantageously operated to dynamically (e.g., automatically) manage inventory in response to present and/or historical booking, usage, environmental, and/or availability data. The machine learning engine 240 May for example, advantageously automatically manage inventory to achieve one or more (predetermined) property personnel preferences.

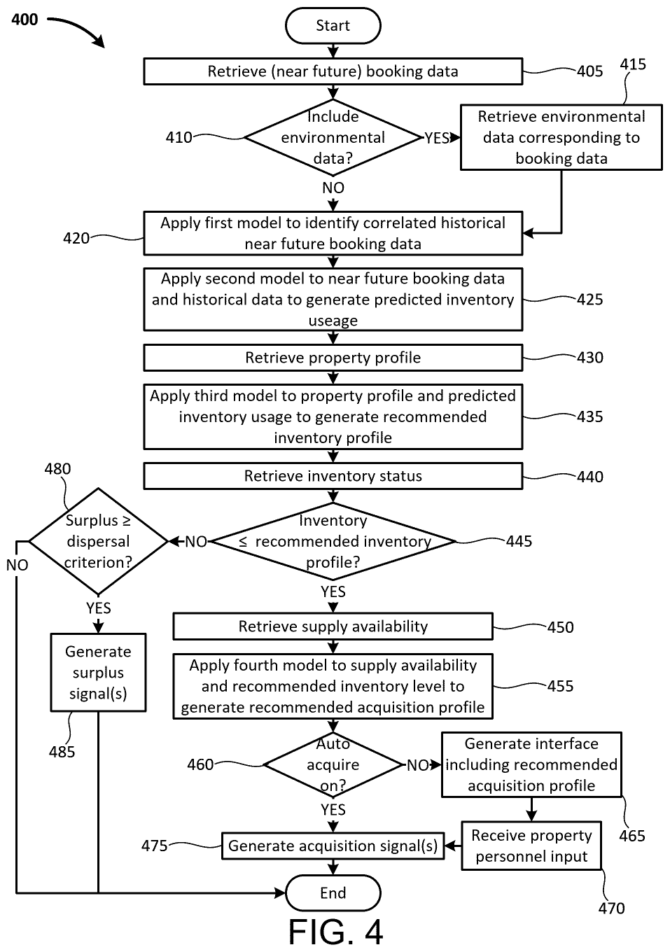

FIG. 4 depicts a flowchart of an exemplary method of managing inventory. In a method 400, booking data is retrieved in a step 405. The booking data may, for example, include near future booking data. The booking data may, for example, include present booking data. In a decision point 410, it is determined whether environmental data should be included (e.g., according to at least one predetermined preference). If yes, then environmental data is retrieved (e.g., a large football game is planned within a date range corresponding to the near future booking data), in a step 415, corresponding to the booking data received in the step 405. Once the environmental data is retrieved, or if it is determined not to include environmental data in the decision point 410, then the method 400 proceeds to a step 420.

In the step 420, a first model is applied to identify correlated historical near future booking data. The first model may, for example, include a booking model (e.g., booking model 325). The first model may, for example, select historical near future booking data as a function of season. The first model may, for example, select historical near future booking data as a function of booking attributes (e.g., customer attributes). The first model may, for example, select historical near future booking data as function of environmental attributes (e.g., historical near future booking data corresponding to similar environmental attributes, such as corresponding to a historical time range in which a large football game has been planned and/or held). The first model may, for example, include the environmental response model 330.

In a step 425, a second model is applied to the near future booking data and the historical data (e.g., historical near future booking data, historical environmental data) identified by the first model. The second model is applied to generate predicted inventory usage. The second model may, for example, include the inventory usage model 335.

A property profile(s) is retrieved in a step 430. The property profile, may, for example, be retrieved from the preference profiles 235e. The property profile may correspond to at least one property associated with the booking data retrieved in the step 405. A third model is applied, in a step 435, to the property profile and the predicted inventory usage to generate a recommended inventory profile in a step 435. The third model may, for example, include the inventory recommendation model 340. The property preference profile may, by way of example and not limitation, include preferred par levels. The property preference profile may, for example, include minimum and/or maximum confidence levels for predicted inventory usage.

An inventory status is retrieved in a step 440. The inventory status may, for example, be retrieved from the inventory status data 235c. In a decision point 445, it is determined if the current inventory status is less than or equal the recommended inventory profile generated in the step 435. If yes, then supply availability is retrieved in a step 450. Supply availability may, for example, be retrieved from the supplies status 235g. A fourth model is applied, in a step 455, to the supply availability and the recommended inventory level to generate a recommended acquisition profile. The fourth model may, for example, include the acquisition model 345. In some embodiments, a hospitality property may include hardware configured to track movement of inventory in real-time. For example, the inventory status may be determined based on the movement (e.g., a quantity of inventory moving into and out of a designated area) of the hospitality property.

If it is determined, in a decision point 460, that an automatic acquire mode is on (e.g., active), then an acquisition signal is generated in a step 475. The acquisition signal may, for example, be generated according to the recommended acquisition profile. The recommended acquisition profile may, for example, include (recommended) purchases and/or leases from one or more vendors and/or other properties to cause the current inventory status to meet or exceed the recommended inventory profile. If it is determined in the decision point 460 that the automatic acquisition mode is not active (e.g., a preference is set corresponding to no automatic acquisition or limitations on automatic acquisition that apply to the recommended acquisition profile) then an interface(s) is generated, in a step 465, including the recommended acquisition profile. The interface(s) may, for example, display recommended items to be acquired. The interface(s) may, for example, display recommended acquisition prices.

The interface(s) may, for example, display recommended acquisition schedules. The interface(s) may, for example, prompt for property personnel input. In a step 470, property personnel input is received (e.g., approving, modifying, and/or denying suggested acquisition), and the method 400 proceeds to the step 475 to generate acquisition signal(s) in response. The method 400 then ends.

In the depicted example, at the decision point 445, if it is determined that the current inventory is greater than the recommended inventory profile (e.g., a predicted surplus exists), then the method 400 proceeds to a decision point 480. At the decision point 480, if the surplus is greater than or equal to one or more dispersal criteria (e.g., a surplus of item X is greater than a value Y with a confidence level of at least Z in the predicted surplus), then a surplus signal(s) is generated in a step 485. The surplus signal may, for example, indicate to one or more (other) properties, vendors, lessees, and/or purchasers that surplus inventory is available for acquisition. The surplus signal may, for example, define a price. The surplus signal may, for example, define a quantity. The surplus signal may, for example, define at least one end of a time window of availability. The method 400 then ends. At the decision point 480, if it is determined that the surplus is not greater than the dispersal criteria, then the method 400 ends.

Accordingly, various embodiments may, for example, advantageously apply (machine-learning) model(s) to dynamically (e.g., automatically) generate suggested inventory acquisitions based on historical booking data, environmental data, property profile(s), inventory status, and/or supply availability. Various embodiments may advantageously provide a technical solution to the problem of automatically acquiring and/or dispersing inventory based on expected usage. Various embodiments may advantageously enable a computer system to apply a system of rules to generate and/or apply models to generate expected usage. Various embodiments may advantageously enable a computer system to apply a system of rules to generate and/or apply models to dynamically suggest and/or manage acquisition and/or dispersal of inventory.

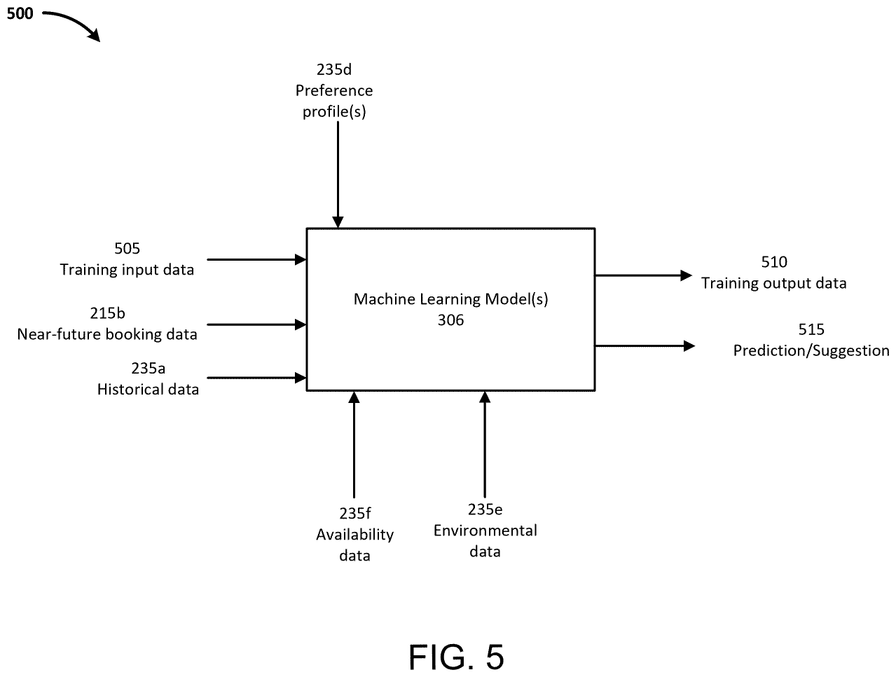

FIG. 5 depicts an exemplary inventory model. An exemplary inventory model 500 may be implemented in the exemplary inventory management system. In this depicted example, the machine learning engine 240 includes at least one of the models 306. The model 306 may, for example, include a neural network model. A neural network model may include, for example, a recurrent neural network (RNN) and/or deep neural network (DNN) model. Different neural network models may be selected. The number of the model layers (e.g., the hidden neurons) may also be determined based on, for example, a complexity of inventory and usage conditions. A set of training data is applied to the model 306 to train the model 306. The training data includes a set of training input data 505 and a set of training output data 510. The set of training input data 505 may include, for example, historical inputs associated with an intended input of the model 306. The set of training output data 510 may, for example, include historical outputs associated with the historical inputs and corresponding to an intended output of the model 306.

For example, the model 306 may include the booking model 325. The set of training input data 505 may include historical booking data 235a (e.g., historical near future booking data, historical occupancy data). The set of training output data 510 may include historical inventory usage data 220b.

The model 306 may, for example, include the environmental response model 330. The set of training input data 505 may, for example, include historical environmental data 235f. The set of training output data 510 may include, by way of example and not limitation, historical booking data 235a, environmental data 235f, and/or historical usage data 235b corresponding to the training input data 505.

The model 306 may, for example, include the inventory usage model 335. The set of training input data 505 may, for example, include historical outputs of the booking model 325 and/or the environmental response model 330. The set of training output data 510 may, for example, include historical usage data 235b.

The model 306 may, for example, include the inventory recommendation model 340. The set of training input data 505 may, for example, include historical outputs of the inventory usage model 335, historical preference profiles 235e, and/or historical supplies status 235g. The set of training output data 510 may, for example, include historical inventory status data 235c.

In some embodiments, before training, a set of testing data (including testing input data and testing output data) may be divided from the training data. After the model 306 is trained, the testing data may be applied to the trained model to test the training accuracy of the model. For example, the trained model may receive the testing input data and generate an output data in response to the testing input data. The generated output data may be compared with the testing output data to determine the prediction accuracy. In some embodiments, one or more models (e.g., neural network models, one or more of the models 306 depicted in FIG. 3) may be cascaded together. The cascaded model may be trained and tested.

Accordingly, the model 306 may be trained to generate a prediction and/or suggestion 515 as a function of the training input data 505 and the output data 510.

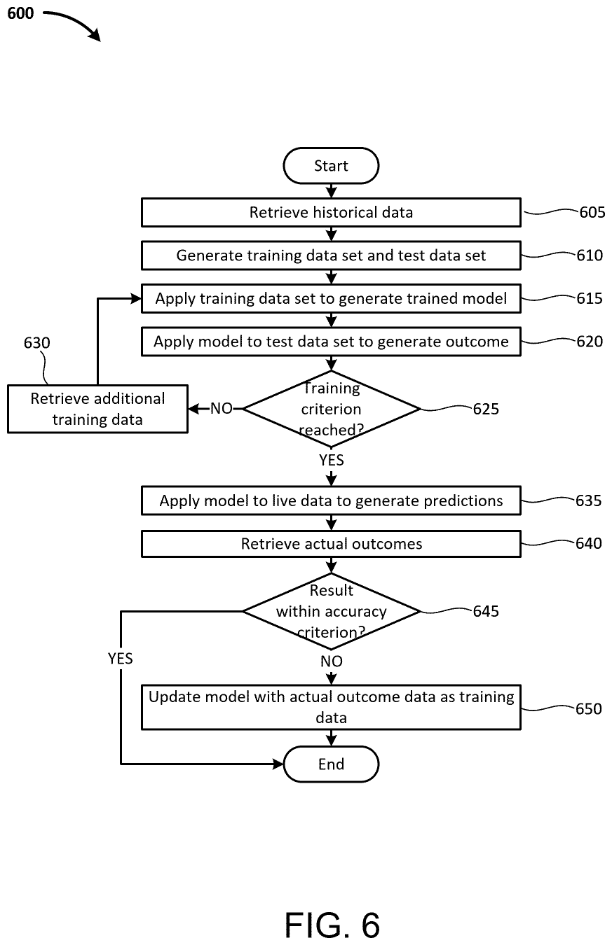

FIG. 6 depicts a flowchart of an exemplary method of training at least one of the inventory models. In a method 600, historical data is retrieved in a step 605. The historical data may, by way of example and not limitation, include historical data of at least one type of data to which a model(s) is intended to be applied and/or generated. For example, historical data may correspond to the training input data 505 and/or the output data 510 disclosed at least with reference to FIG. 5. From the historical data retrieved in the step 605, at least one training data set and at least one test data set are generated in a step 610. The historical data may, for example, be divided into training data and/or test data as disclosed at least with reference to FIG. 5. The training data set may, for example, correspond to the training input data 505 and/or the output data 510. In some embodiments the training data set may be matched by one or more attributes (e.g., time, environmental, customer attributes, property) to the test data set. In some embodiments the training data set may be substantially entirely independent from the test data set (e.g., having unique, non-duplicated entries relative to the test data set).

The training data is applied, in a step 615, to generate a trained model. The model may, for example, include one or more untrained or previously trained machine learning models (e.g., model(s) 306). The model(s) may be applied to the training data (e.g., input and/or output data) such that the model generates one or more model elements operative to cause the model to generate, in response to test input data, outputs corresponding to the associated test output data. The model elements may, for example, include parameters. The model elements may, by way of example and not limitation, include weighting factors. The model elements may, for example, include classifications. The model elements may, for example, include nodes. The model elements may, for example, include connections (e.g., with associated weights). The model elements may, for example, include one or more (hidden) layers.

The (trained) model is applied to the test data set(s) to generate an outcome in a step 620. The trained model may, for example, be applied to test data corresponding to intended input data (e.g., input data types). The trained model may, for example, generate an output based on the training performed in the step 615. In a decision point 625, it is determined if at least one training criterion is reached. For example, the output from the model generated in the step 620 in response to the test (input) data may be compared to corresponding test (output) data. If the training criterion is not reached (e.g., a predetermined minimum percentage accuracy), then additional training data is retrieved in a step 630 and the method 600 returns to the step 615. For example, test data may be applied as training data. An interface(s) may be generated for at least one user containing, for example, test result(s) from the step 620 and/or the decision point 625 (e.g., input, actual output, expected output, accuracy results). The interface(s) may, for example, prompt a user for additional test data. In some embodiments additional (historical) data may be retrieved automatically to generate additional test data.

Once it is determined, in the decision point 625, that the at least one training criterion has been reached, then the model is applied to live data to generate predictions in a step 635. The model may, for example, be applied to current data generated, retrieved, received, or some combination thereof. The model may, for example, generate one or more predictions. The model may, for example, generate one or more suggestions. The model(s) may, for example, be applied as disclosed at least with reference to FIGS. 1-5.

In the depicted example, the actual outcomes corresponding to at least some of the live data are retrieved in a step 640. The actual outcomes may, for example, include actual occupancy data corresponding to near future booking data to which the model was applied to generate predicted occupancy data. The actual outcomes may, by way of example and not limitation, include actual linen usage data corresponding to near future booking data to which the model(s) was applied to generate predicted usage data (e.g., of linens, food, staff). In some embodiments the actual outcomes may, for example, include actual occupancy and/or usage data corresponding to environmental data to which the model(s) was applied. The actual outcomes may, in some examples, include actual usage, service, and/or customer satisfaction data corresponding to preference profiles to which the model(s) was applied. The actual outcomes may, for example, include actual acquisition data corresponding to supply status data to which the model(s) was applied (e.g., aggregated, per property, per vendor).

The generated predictions and the corresponding actual outcomes are compared, in a decision point 645, to determine if the result of the model (e.g., the generated predictions) are within at least one accuracy criterion (e.g., predetermined minimum accuracy threshold, predetermined minimum customer satisfaction level, predetermined minimum inventory level). The accuracy criterion may, for example, be defined in a preference profile. If the result is within the at least one accuracy criterion, then the depicted method 600 ends. If the result is not within the at least one accuracy criterion, then the model(s) is updated, in a step 650, with the actual outcome data as training data (e.g., according to step 615, according to steps 605-630), and the method 600 ends.

In some embodiments the steps 635 through 650 may, by way of example and not limitation, be omitted. In some embodiments the decision point 625 and the step 630 may, for example, be omitted. In some embodiments the depicted method 600 may, for example, provide a method by which a computer (system) may advantageously dynamically generate an updated model(s) in response to comparison to actual data. For example, a property management system may be advantageously dynamically updated. A hospitality management system may advantageously be provided which solves an exemplary problem of enabling a computer (system) to increasingly accurately and/or self-adaptively automatically manage linen inventory (e.g., including prediction, preferences, and/or acquisition). For example, some embodiments may advantageously provide a system which automatically adapts to, by way of example and not limitation, changing preferences (e.g., of customers, of managers), behavior, conditions, supplies, or some combination thereof, to maintain a (predetermined) accuracy criterion in inventory management (e.g., of linens).

FIG. 7 depicts a flowchart of an exemplary method of generating an inventory usage prediction. In a method 700, property preference input signals are received in a step 705. The signals may, for example, be generated by retrieving preference inputs from at least one datastore. The signal may, for example, be generated in response to inputs received from a user through a (personal) computing device. The computing device may, for example, display to the user a series of prompts for input. The prompts for input may, for example, include questions. The questions may, for example, be configured to generate a profile of the user's preferences regarding at least one property. The questions may, by way of example and not limitation, relate to inventory levels (e.g., par levels), minimum and/or maximum confidence interval thresholds, customer satisfaction, cost, or some combination thereof. In some embodiments the signals may, for example, be generated as result of customer and/or management feedback based on actual outcomes corresponding to generated predictions (e.g., usage prediction, cash flow prediction, acquisition suggestion, acquisition signal).

A property preference profile(s) is generated, in a step 710, from the property preference input signals. The property preference profile may, for example, be generated as a metadata structure. The property preference profile may, for example, be generated as a structured data file. The property preference profile may be associated with at least one property. The property preference profile may be associated with at least one user (e.g., manager, property personnel 150). The property preference profile may be stored in a datastore (e.g., preference profiles 235e datastore).

Data is retrieved in a step 715. In the depicted example, the data includes near future booking data. A model(s) (e.g., model 306, inventory usage model 335, booking model 325) is applied to the data based on the property preference profile to generate an inventory usage prediction in a step 720. For example, weights of the (machine-learning) model may be modified by the preference profile. Hidden layers may, for example, be adjusted (e.g., added, modified) by the preference profile. The model may, for example, generate a usage prediction as a function of a minimum par level defined in the property preference profile.

A confidence level (e.g., confidence interval) is generated, in a step 725, based on the property preference profile and historical data. The model(s) may, for example, be presently applied to the historical data. The model(s) may, for example, already incorporate the historical data via training, such as disclosed at least with reference to FIGS. 5-6. The confidence level may, for example, represent a confidence in the prediction based on parameter(s) of the property preference profile (e.g., a minimum confidence level). The confidence level and/or the inventory usage prediction may, for example, be displayed to a staff (e.g., property personnel 150).

If the confidence level(s) is not accepted (e.g., by the staff associated with the property), in a decision point 730, then the property preference profile(s) is updated in a step 735. For example, if it is indicated (e.g., by the staff) that the confidence level is too low, the property preference profile may be automatically updated to correspond to a higher minimum confidence level. If, for example, it is indicated (e.g., by the staff) that the inventory usage is too high for the data (e.g., expected occupancy, current near future booking data), the property preference profile may be automatically updated to correspond to a lower par level and/or lower minimum confidence level. Accordingly, various embodiments may advantageously allow a preference profile(s) for a property to be (automatically) updated based on user feedback. The preference profile(s) may, for example, be updated based on indirect feedback (e.g., feedback on results) without requiring direct adjustment of the preferences by user(s).

Once the property preference profile is updated in the step 735, then the method 700 returns to the step 720. If the confidence level(s) is accepted in the decision point 730, then the inventory usage prediction is stored (e.g., in a datastore such as data structure 235) and/or transmitted (e.g., to a property management system, to a user's computing device) in a step 740, and the method 700 ends.

FIG. 8 depicts a flowchart of an exemplary method of applying an inventory model(s) to generate an acquisition signal(s). In a method 800, a property preference profile is retrieved (e.g., by the processor 305 from the preference profiles 235e datastore) in a step 805. In the depicted example, environmental data is retrieved in a step 810 (e.g., by the processor 305 from the environmental data 235f). Booking data is retrieved in a step 815 (e.g., by the processor 305 from the near future booking data 235d).

In a step 820, a model(s) is applied to the retrieved booking data (e.g., including near future booking data) and retrieved environmental data, based on the retrieved property preference profile(s), to generate a recommended inventory profile. The model may, for example, include the model 306. The model may, for example, include the environmental response model 330. The model may, for example, include the booking model 325. The model may, for example, include the inventory usage model 335. The model may, for example, include the inventory recommendation model 340. The step 820 may, for example, include generation of an inventory usage prediction (e.g., as disclosed at least with reference to FIG. 7).

The recommended inventory profile may, for example, include recommended inventory type. The recommended inventory profile may, for example, include recommended inventory quality. The recommended inventory profile may, for example, include recommended inventory per unit time (e.g., day, week, month, quarter). The recommended inventory profile may, for example, be generated as a function of the booking data and the environmental data.

Inventory status is retrieved (e.g., by the processor 305 from the inventory status data 235c datastore) in a step 825. The inventory status may, for example, include a current available quantity of inventory, current available types of inventory, or some combination thereof. The inventory status is compared to the recommended inventory profile in a decision point 830. If the inventory status is greater than or equal to the recommended inventory profile, then no additional inventory may be needed, and the method 800 ends. If the inventory status is not greater than or equal to the recommended inventory profile, then a recommended acquisition profile is generated in a step 835. The recommended acquisition profile may, for example, be generated by applying at least one acquisition model (e.g., applying the acquisition model 345 by the processor 305) to the recommended inventory profile, the inventory status, the property preference profile, or some combination thereof.

In some embodiments, for example, the recommended acquisition profile may include a recommended acquisition of inventory per unit time to achieve the recommended inventory profile. The recommended acquisition may, for example, be determined based on the property preference profile (e.g., rent vs buy, preferred lead time, preferred vendors, cash flow preferences). The recommended acquisition profile may, for example, be determined as a function of supply availability data (e.g., the supplies status 235g). The supply availability data may, for example, include availability data from a vendor. The supply availability data may, for example, include availability from another property.

The recommended acquisition profile generated in the step 835 may be presented to a user (e.g., property personnel 150). The user may, for example, include a purchasing manager. If it is determined, in a decision point 840, that the acquisition profile is not accepted (e.g., determined in response to at least one signal received from the user), then updated inputs are received, in a step 845, and the method 800 returns to the step 835. For example, the updated inputs may include modifications to the acquisition profile (e.g., inventory items, inventory types, inventory quantity, purchase timing, rent vs buy, acquisition sources).

Once the recommended acquisition profile is accepted in the decision point 840, then a projected cash flow profile is generated in a step 850. For example, the projected cash flow profile may be generated by and/or may be based on the acquisition model 345. The projected cash flow profile may, for example, be generated as a function of the (approved) acquisition profile based on corresponding generated purchase orders, estimates, invoices, or some combination thereof.

The cash flow profile generated in the step 850 may be presented to a user (e.g., property personnel 150). The user may, for example, include a financial manager (e.g., CFO, accountant, manager). If it is determined, in a decision point 855, that the projected cash flow profile is not accepted (e.g., determined in response to at least one signal received from the user), then updated inputs are received in the step 845. For example, inputs from the user (e.g., financial manager) may be provided. Updated inputs may, for example, include budgetary constraints. Updated inputs may, for example, include cash flow constraints. Updated inputs may, for example, include timing of expenditures. Updated inputs may, for example, include maximum expenditure per unit time. Updated inputs may, for example, include shifting of expenditures to different times than recommended. Updated inputs may, for example, include shifting of expenditure levels at one or more times different than recommended. Updated inputs may, for example, include shifting between buying and renting during at least one time period (e.g., to reduce and/or avoid negative cash flow during slow times). In response to the updated inputs, the method 800 returns to the step 835.

Once the cash flow profile is accepted, in the decision point 855, then acquisition signals are generated, in a step 860, according to the acquisition profile. The acquisition signals may, for example, include the acquisition signals 245b generated by the inventory acquisition engine 245. The acquisition data 245a may, for example, include the (approved) acquisition profile.

Accordingly, various embodiments may advantageously enable a computer (system) to (automatically) manage acquisition of inventory based on preferences, environmental data, and/or booking data. The acquisition may, for example, be automatically managed based at least partially on human feedback (e.g., without requiring direct entry and/or estimation of acquisition). Various embodiments may advantageously permit hospitality inventory to be automatically and dynamically managed.

FIG. 9 depicts a flowchart of an exemplary method of applying an inventory model(s) to (automatically) distribute projected surplus across a network. In a method 900, current data is retrieved in a step 905. The current data, in the depicted example, includes booking data (e.g., near future booking data). The booking data may, for example, be retrieved by the processor 305 from the data structure 235 (e.g., including the near future booking data 235d). In a step 910, one or more models (e.g., model 306) are applied to the current data to generate a recommended inventory profile(s) (e.g., as disclosed at least with reference to FIG. 8).

Current inventory status is retrieved, in a step 915, corresponding to the recommended inventory profile. The current inventory status is compared, in a decision point 920, to the recommended inventory profile. If the current inventory is not greater than a recommended inventory profile, then the method ends. In some embodiments, for example, a method may be initiated such as beginning at step 835 of the method 800 disclosed at least with reference to FIG. 8.

If the current inventory is greater than a recommended inventory profile, then a surplus projection is generated, in a step 925. The surplus projection is generated based on the current data, the preference profile(s), and the recommended inventory profile(s). The surplus projection may include, by way of example and not limitation, projected surplus inventory types, projected surplus inventory items (e.g., corresponding to the inventory types), projected surplus quantity (e.g., corresponding to the inventory items), projected surplus time(s) (e.g., corresponding to the inventory items and associated quantities). The surplus projection may, for example, be at least partially generated by the inventory recommendation model 340. The surplus projection may, for example, be at least partially generated by the inventory usage model 335. The surplus projection may, for example, be at least partially generated in response to outputs of the inventory recommendation model 340 and/or the inventory usage model 335. For example, in some embodiments the surplus projection profile may be determined as a difference (e.g., aggregate, per unit time) between the recommended inventory profile and the current inventory status.

If a surplus criterion is determined, in a decision point 930, to not be reached (e.g., one or more predetermined surplus criterion), then the method 900 ends. The surplus criterion may, for example, include a minimum (e.g., predetermined minimum) excess over the recommended inventory profile. The surplus criterion may, for example, include a minimum confidence level(s) (e.g., confidence intervals) associated with the recommended inventory profile. The surplus criterion may, for example, be automatically generated. The surplus criterion may, for example, be defined in a property preference profile.

If a surplus criterion is determined to be reached, then a surplus availability signal(s) is generated in a step 935. The surplus availability signal(s) may, for example, include inventory items available. The surplus availability signal(s) may, for example, include quantity of inventory available. The surplus availability signal(s) may, for example, include times at which inventory is available. The surplus availability signal(s) may, for example, include lead times associated with available inventory. The surplus availability signal(s) may, for example, include terms of acquiring the available inventory (e.g., lease vs buy, price, return conditions, lease length). The surplus availability signal(s) may, for example, be transmitted to a vendor. The surplus availability signal(s) may, for example, be transmitted to a marketplace (e.g., as disclosed at least with reference to the additional property 140 of FIG. 1).

If, in a decision point 940, it is determined that the availability signal(s) is not matched with at least one acquisition signal(s) (e.g., no entity chose to acquire surplus inventory from the offering property/entity), then the method 900 ends. If it is determined that the availability signal(s) is matched with at least one acquisition signal(s), then a transaction is generated in a step 945 and inventory status is updated in a step 950. The matching may, for example, be performed by a central management system (e.g., a centrally deployed property management system 105). The matching may, for example, be performed by a marketplace management system. The matching may, for example, be performed directly by a property (e.g., the additional property 140) seeking to acquire inventory. The matching may, for example, be performed by a vendor.

Accordingly, various embodiments may advantageously provide automatic management of identification and/or dispersal of surplus inventory. Various embodiments may advantageously enable a computer (system) to solve an exemplary problem of automatically balancing inventory levels with projected inventory usage (e.g., according to future booking data and/or property preferences). Various embodiments may advantageously improve cash flow (e.g., reduce expenses associated with keeping inventory, increase cash flow by dispersing inventory). Various embodiments may advantageously (automatically) adjust inventory levels to projected seasonal adjustments based on historical and/or current data.

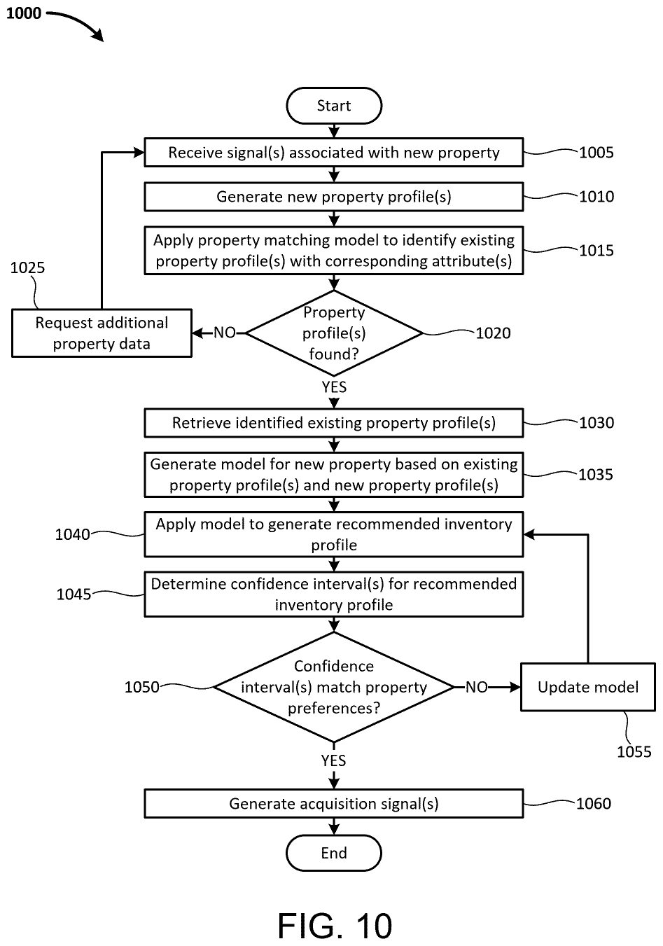

FIG. 10 depicts a flowchart of an exemplary method of applying an inventory model(s) to (automatically) provision a (new) property. In a method 1000, a signal associated with a new property is received in a step 1005. The new property may, for example, be a new property managed by a property management system (e.g., the property management system 105). At least one new property profile is generated in a step 1010. The property profile may, for example, include at least one property preference profile. The property profile may, for example, define one or more attributes of the property. The attributes may, by way of example and not limitation, include property type (e.g., restaurant, hotel, theme park, hospital, bed and breakfast). The attributes may, for example, include size data (e.g., number of beds, number of square feet). The attributes may, for example, include location data (e.g., address, metro, state, geographical region). The attributes may, for example, include staff data (e.g., staff types, staff numbers). The attributes may, for example, include customer data (e.g., target customer profiles).

A property matching model(s) is applied, in a step 1015, to identify existing property profile(s) with corresponding attributes. The existing property profile(s) may, for example, be retrieved (e.g., by the processor 305) from the data structure 235. For example, the property profile(s) may include preference profiles from the preference profiles 235e datastore. The model may, for example, be one of the models 306. The property matching model is not depicted in FIG. 3. The property matching model may, for example, be applied to the existing property profiles and the new property profiles. The property matching model may identify at least one existing property profile that is a suggested match to the new property profile. The existing property profile may, for example, be associated with historical data corresponding to at least one existing property associated with the existing property profile.

If it is determined, in a decision point 1020, that an existing property profile is not found (e.g., no closest match found, no match found meeting at least one (predetermined) criterion), then additional property data is requested in a step 1025. The additional property data may, for example, include additional attributes. In some embodiments, the step 1025 may be omitted. In some embodiments, matching criterion may, for example, be relaxed. In some embodiments, multiple existing property profiles may be blended based on attributes of the new property profile(s) (e.g., to generate a ‘hybrid’ property profile with associated historical data selected according to corresponding attributes in the hybrid property profile).

Once it is determined, in the decision point 1020, that an existing property profile(s) is found, then the identified existing property profile(s) is retrieved (e.g., from at least one datastore) in a step 1030. At least one model is generated for the new property, in a step 1035, based on the existing property profile(s) and the new property profile(s). For example, generating the at least one model for the new property may include adapting an existing model(s). Generating the at least one model for the new property may include, training a new and/or existing model(s). Generating the at least one model for the new property may include, for example, selecting an existing model. Generating the at least one model for the new property may include, for example, retrieving historical data associated with the existing property profile(s) (e.g., to generate and/or train the new model(s)).

The (new) model(s) is then applied, in a step 1040, to generate a recommended inventory profile for the new property. Generating the recommended inventory profile may, for example, include generating a predicted inventory usage profile. Generating the recommended inventory profile may, for example, include generating and/or updating a property preference profile(s). The recommended inventory profile may, for example, be based on current and/or historical data for the associated existing property(s). The recommended inventory profile may, for example, be based on current data for the associated existing property(s). The recommended inventory profile may, for example, be based on historical data associated with the existing property(s) and associated with specific attributes of the new property. As an illustrative example, an existing property may be selected, and historical data from that existing property may, by way of example and not limitation, be selected based on a current season, environmental data, and/or customer attributes, associated with the new property.

A confidence interval(s) is determined, in a step 1045, for the recommended inventory profile. The confidence interval(s) may indicate a level of confidence in the recommended inventory profile. The confidence interval(s) may, for example, be based on correspondence of the new property profile(s) to the selected existing property profile(s). The confidence interval(s) may, for example, be based on the recommended inventory profile. The confidence interval(s) may, for example, be based on historical data and/or current data associated with the existing property profile(s), the historical data and/or current data used to generate the recommended inventory profile.

In a decision point 1050, the confidence interval(s) are compared to property preferences (e.g., defined by a new property profile(s)). If the confidence interval(s) are determined to not match the property preferences (e.g., based on a preferred service level, preferred customer experience, preferred confidence), then the model(s) is updated in a step 1055. If the confidence interval(s) are determined to match the property preferences, then acquisition signal(s) are generated in a step 1060. In some embodiments the step 1060 may, by way of example and not limitation, include at least some of steps 835-860 of the method 800 as disclosed at least with reference to FIG. 8.

Accordingly, various embodiments may advantageously automatically generate inventory predictions based on existing properties. For example, an exemplary embodiment may advantageously enable a computer (system) to generate a recommended linen inventory profile for a new hotel based on existing properties (e.g., other hotels) having historical and/or current data. Various embodiments may advantageously provide a technical solution to an exemplary problem of automatically determining inventory levels for a property (e.g., hotel) for which no historical data is present to generate (e.g., train) a model.

Although various embodiments have been described with reference to the figures, other embodiments are possible.

In some implementations, the property management system 105 may predict preventive maintenance. For example, the property management system 105 may, based on a near future booking data and environmental attribute to determine a high inventory usage. For example, the property management system 105 of a resort hotel may determine that a high towels usage in near future because of a high near future booking data and a high temperature (e.g., customer will be likely to use the swimming pool more frequently). In some implementations, the property management system 105 may manage a towel inventory preventively by triggering an acquisition signal to the processing center 130 and the vendor 135. For example, the property management system 105 may maintain a higher towel inventory than usual. In some implementations, the property management system 105 may generate signals for predictive maintenance based on related inventory usage (e.g., washing machine repair based on upcoming predicted linen usage).

In some implementations, an inventory model(s) may be updated based on realtime spoilage rates. For example, a predicted linen usage and/or inventory acquisition model(s) may be updated based on ragout history. A machine-learning model may automatically update based on historical spoilage rates.

In some implementations, a model(s) may be generated based on environmental data.

Various implementation may advantageously be configured to respond to predicted disruptions. For example, a model may be applied to historical data to be trained on correlations of historical hotel occupancy forecast with inventory usage. Statistical correlations to one or more corresponding events may be determined. Accordingly, the model may be configured to detect and predict a future disruption based on one or more future events on a calendar. For example, the disruption may not be reflected (e.g., yet) in an occupancy forecast, but the disruption model(s) may generate a predicted inventory update based on the event (e.g., season).

Although various embodiments have been disclosed with reference to hospitality such as restaurants and hotels, other hospitality implementation and/or other implementations (e.g., not related to hospitality) are possible. For example, housing inventory and/or inventory related to housing may be dynamically acquired and/or controlled. In some implementations, by way of example and not limitation, popup inventories (e.g., temporary oilfield housing) may be controlled. In some implementations, by way of example and not limitation, short term housing and/or short term rentals inventory may be dynamically maintained.

For example, disaster response (e.g., COVID centers) centers inventory and/or accessibility may be controlled. In some implementations, for example, military inventory may be controlled. As an illustrative example, spinup and/or spindown of base camp and/or related inventory may be controlled. In some implementations, for example, inventory related to satellite launches with rockets may be controlled.

Industrial inventory may be controlled, for example, in some implementations. As an illustrative example, clean rooms (e.g., for manufacturing) may be managed. Hazmat uniforms may, for example, be dynamically controlled. Safety equipment (e.g., personal protective equipment) may, for example, be dynamically controlled. Such equipment may, for example, be managed through new acquisition and/or restoration (e.g., cleaning, inspection, storage).

Medical inventory may, for example, be controlled, in some examples. For example, clothing and/or reusable equipment may be controlled through new acquisition and/or restoration processes.

For example, various implementations may advantageously be configured to manage reusable inventory assets. Such implementations may, for example, manage inventory through determination whether used inventory is permissible to reenter the supply chain. Implementations managing inventory through restoration (e.g., re-entry) processes may advantageously predict inventory usage, inventory restoration, new acquisition, and/or availability (e.g., of restoration, of new acquisition) to generate corresponding acquisition signals (e.g., new acquisition, restoration service acquisition).

In some implementations, a machine learning model(s) may be configured to detect and/or predict an anomaly in processes (e.g., acquisition, usage, restoration) based on historical data. A system may, for example, be configured to, in response to detection/prediction of the anomaly, issue an alert. The alert may, by way of example and not limitation, be issued to a system, another model, and/or a user. The alert signal may indicate that something in at least one process is out of ordinary. Accordingly, appropriate steps may be taken to prevent disruption even if historical data does not indicate a solution.

As an illustrative example, an alert may be raised based on spoilage rates suddenly rising out of historical parameters and/or patterns. An alert may, for example, be raised if inventory usage (e.g., detergent) changes beyond historical quantities and/or patterns. The alert may, for example, be used to indicate that a disruption and/or fault may be occurring in a process. The alert may, for example, indicate the anomaly detected and/or related information (e.g., historical data) such that, for example, a user may identify a root cause.

Various implementations may, for example, include an event calendar. The event calendar may, for example, include scheduled events (e.g., social events, political events, historical events, weddings, games, meetings). The calendar may, for example, include unexpected events (e.g., forest fires, tornadoes, hurricanes). One or more models may be configured to predict usage and/or availability based on one or more of the calendar event(s). As an illustrative example, if a calendar event includes a forest fire, model(s) corresponding to locations near the fire and/or locations along an expected path of travel for firefighters may adjust inventory usage accordingly (e.g., for hotels, bed and breakfasts, government facilities, firefighting supply warehouses). A model(s) corresponding to properties affected by wildfires may, for example, seasonally predict increased usage corresponding to fires being more active in summer than winter.

In some embodiments, by way of example and not limitation, inputs to an inventory control system and/or associated model(s) may include a reusability cycle lead time (e.g., how long to get inventory cleaned and/or otherwise reusable, such as maintenance processing). Inputs may, for example, include new lead time (e.g., how long to get new inventory). Inputs may, for example, include spoilage prediction. Inputs may, for example, include demand input (e.g., near-future data corresponding to usage, such as near-future booking data).

In some implementations, the reusable inventory may include other forms of textile (e.g., industrial uniforms, decorative uniforms). For example, the property management system 105 may include an inventory checking system to monitor inventory of reusable products. In some implementations, the reusable inventory may include restaurant supplies (e.g., glasses, plates, silverware). For example, the processing center 130 may include washing facilities of tableware.

In some implementations, the property management system 105 may include an automated inspection process. For example, the automated inspection process may be performed through optical hardware and software (e.g., computer vision, image processing) to identify spoilage. For example, the automated inspection process may be applied to monitor restaurant supplies. For example, the automated inspection process may include a monitoring module for a continuous dishwasher. For example, the monitoring module may include image processing to inspect and determine spoilage. Some automated inspection techniques may include visual, soundwave (e.g., to detect crystal dishes not ringing with certain tone to determine broken dishes), chemical sensors (e.g., smell), for example.

For example, inventory may be monitored at different stages and/or locations in use. Inventory may, for example, be monitored during restoration (e.g., laundering, repair). Inventory may, for example, be monitored during ordering. Inventory may, for example, be monitored during inspection. Inventory may, for example, be monitored during transit.

By way of example and not limitation, inventory may be monitored by physical identification. For example, a physical identifier may be monitored by one or more networked devices. A physical identifier may, for example, include an RFID tag. A physical identifier may, for example, communicate with a reader device by near-field communication (e.g., Bluetooth, Zigbee).

In some implementations, inventory may be monitored by visual inspection. For example, visual inspection results may be entered at an inspection station. Visual inspection may, by way of example and not limitation, be performed by computer vision. For example, one or more cameras may monitor assets (e.g., linens, dishes, equipment) at one or more predetermined stations. A processor may apply image recognition to an image stream, for example. For example, the image recognition may be applied to determine an asset type. The image recognition may, for example, be applied to determine a status of the asset (e.g., clean, dirty, new, useable, worn-out/unusable). For example, predetermined parameters and/or models (e.g., object models, pattern models) may be applied. In some implementations, by way of example and not limitation, the predetermined parameters and/or models may be generated and/or updated by machine learning. For example, a machine learning model(s) may be trained by comparing outputs of the model(s) to historical and/or human-determined classifications of corresponding objects.

Although an exemplary system has been described with reference to the figures, other implementations may be deployed in other industrial, scientific, medical, commercial, and/or residential applications.

In various embodiments, some bypass circuits implementations may be controlled in response to signals from analog or digital components, which may be discrete, integrated, or a combination of each. Some embodiments may include programmed, programmable devices, or some combination thereof (e.g., PLAs, PLDs, ASICs, microcontroller, microprocessor), and may include one or more data stores (e.g., cell, register, block, page) that provide single or multi-level digital data storage capability, and which may be volatile, non-volatile, or some combination thereof. Some control functions may be implemented in hardware, software, firmware, or a combination of any of them.

Computer program products may contain a set of instructions that, when executed by a processor device, cause the processor to perform prescribed functions. These functions may be performed in conjunction with controlled devices in operable communication with the processor. Computer program products, which may include software, may be stored in a data store tangibly embedded on a storage medium, such as an electronic, magnetic, or rotating storage device, and may be fixed or removable (e.g., hard disk, floppy disk, thumb drive, CD, DVD).

Although an example of a system, which may be portable, has been described with reference to the above figures, other implementations may be deployed in other processing applications, such as desktop and networked environments.

In various embodiments inventory may, for example, be (automatically) managed according to property preferences. For example, a budget hotel may prioritize cost savings over confidence of inventory levels. A budget hotel may, for example, not suffer significant decreased bookings due to occasional shortages in laundry inventory (e.g., sheets, towels). Accordingly, a budget hotel may prefer prioritizing minimizing cash flow over inventory reserves. A budget hotel may, for example, only require a par level of 2×-3×. On the other hand, a five-star hotel may prioritize customer satisfaction over a certain level of cost savings. A five-star hotel may, for example, risk significant decreased bookings due to even a single shortage in laundry inventory. Accordingly, a five-star hotel may prefer prioritizing inventory reserves (e.g., to achieve a high confidence level of being able to supply fresh linens to all customers) over cash flow savings provided by a smaller inventory level. For example, a five-star hotel may prefer to maintain at least 4× par level.

Some embodiments may generate a preference profile (e.g., including a par level for one or more inventory items) for a property based on manager attitudes regarding risk. The profile may, for example, be used to imply how much par level the manager(s) wants to maintain of their inventory. At least one probability may be calculated. For example, an interface may be displayed to a manager(s) indicating that with a given set of conditions, and a given (e.g., implied preferred) par level, then the manager(s) has a 90% chance of meeting their obligations (e.g., fresh linens daily to customers). The interface may, for example, display that if a different set of conditions happens, the chance decreases to 70%. The interface may display, for example, that if the par level was decreased under the first given set of conditions, the chance decreases to 65%. The interface may, for example, display that if the par level was increased under the different set of conditions, then the chance increases to 89%. The interface may, for example, allow a manager to provide input(s) (e.g., desired percent confidence in meeting obligations, alter obligations, alter conditions). In some embodiments an interface may, for example, include a display that compares a property and/or manager's risk tolerance score to a current par level. The display may, for example, indicate relative risk (e.g., by colors, by at least one dial, by at least one slider).

The preference profile (e.g., risk preference profile) may, for example, be generated based on (manager) answers to questions correlated to risk. For example, the questions may include how afraid a manager(s) is of inability to meet obligations. A higher fear may, for example, correlate to a higher (recommended) par level. Questions may, for example, include sensitivity to customer ratings. For example, if customers are forced to use the hotel due to availability, but leave bad reviews, user input may be used to determine how sensitive the manager(s) is to bad reviews if revenue does not necessarily suffer. Accordingly, various embodiments may advantageously generate at least one metric of risk tolerance for each manager and/or property. In some embodiments the risk tolerance metric may be updated periodically (e.g., new management, seasonal changes, continuously based on manager feedback to results, historical behavior such as overriding automatic recommendations, fixed time schedule). For example, a survey may be provided at least once a year. The survey may, for example, be provided at least four times a year. The survey may, for example, be provided on demand.

In various embodiments inventory level preferences may be dynamically adjusted. For example, inventory level preferences may be automatically adjusted seasonally. In an exemplary embodiment, a preference profile for a hotel may be generated based on seasonality pattern(s). The seasonality pattern(s) may, for example, be generated based on historical data. A historical purchasing profile may, for example, be generated. The historical purchasing profile may, for example, indicate that a hotel purchases less during certain seasons (e.g., due to reduced cash flow). The reduced purchases may correspond to a reduced par level. The historical purchasing profile may, for example, indicate that a hotel purchases more during other seasons (e.g., due to higher demand, fluctuations, and/or cash flow). The increased purchases may, for example, correspond to higher par levels. Accordingly, a property management system (e.g., property management system 105) may, by way of example and not limitation, dynamically adjust the preference profile(s) of the property based on season (e.g., according to the seasonality pattern(s) generated). The property management system may dynamically adjust inventory predictions and/or suggestions dynamically according to the dynamically adjusted preference profile(s).

In some embodiments inventory predictions and/or suggestions may be determined based off a cost-benefit analysis (e.g., cash flow impact vs customer satisfaction impact). The cost-benefit analysis may, for example, be predicted by at least one model. The cost-benefit analysis may, for example, be analyzed according to predetermined criteria in a preference profile(s).

Various embodiments may include, apply spoilage rates to current inventory status. For example, a predicted inventory usage profile may be based on predicted and/or historical spoilage rates for various inventory items. In various embodiments, spoilage rates may be determined based on manufacturer recommendations. Spoilage rates may, for example, be determined based on property profile(s) (e.g., quality criteria). Spoilage rates may, for example, be determined based on historical data (e.g., reorder rates). In some embodiments spoilage rates may be determined, by way of example and not limitation, as a function of manufacturer and/or industry recommendations modified by property profile(s).

In some implementations, spoilage rates may be determined in real-time based on ragout history. In some implementations, the ragout history may be applied to a machine learning model to generate a predictive spoilage rate based on correlated attributes (e.g., booking attributes, environment attributes).

In various embodiments, a recommended inventory profile may include local inventory (e.g., maintained on premises of a property). In some embodiments a recommended inventory profile may include, for example, remote inventory. Remote inventory may, for example, include inventory maintained at a remote location. Remote inventory may, for example, be maintained by a third party. An inventory provider may, for example, hold reserve inventory for a property. The inventory provider may, for example, hold fractional reserves based on predicted usage (e.g., based on historical behavior) of multiple customers holding reserve inventory at the inventory provider. In an illustrative example, the inventory provider may include a laundry service provider. The laundry service provider may, for example, hold linens in reserve based on acquisition signals from one or more properties (e.g., representing lease and/or purchase transactions).

In some embodiments a service provider (e.g., the processing center 130) may be managed by a property management system (e.g., the property management system 105). The property management system may, for example, maintain a ‘digital twin’ of the service provider's physical property and/or capacities. The service provider may, for example, be a laundry service provider. The laundry service provider may, for example, have one or more processing facilities. Each processing facility may have a certain amount of processing capacity. The property management system may apply one or more models (e.g., the model 306) to generate a prediction of capacity usage (e.g., as a function of predicted inventory usage, as a function of acquisition signals, as function of historical behavior). The property management system may, for example, in response to determining a predicted shortage in processing capacity, generate service acquisition signal(s) (e.g., corresponding to looking for additional service capacity). The acquisition signal(s) may, for example, define service type, service attributes (e.g., specific steps and/or capabilities), service costs, geographical location, or some combination thereof. In some embodiments, acquisition signal(s) may, for example, be generated and/or transmitted based on density (e.g., to send laundry to a processing center 1 block away instead of 50 miles away).

In some implementations, the machine learning engine 240 may detects an anomaly (e.g., all of a sudden spoilage goes up, or detergent use goes up). For example, the machine learning engine 240 may issues an alert based on the detected anomaly.

Temporary auxiliary energy inputs may be received, for example, from chargeable or single use batteries, which may enable use in portable or remote applications. Some embodiments may operate with other DC voltage sources, such as batteries, for example. Alternating current (AC) inputs, which may be provided, for example from a 50/60 Hz power port, or from a portable electric generator, may be received via a rectifier and appropriate scaling. Provision for AC (e.g., sine wave, square wave, triangular wave) inputs may include a line frequency transformer to provide voltage step-up, voltage step-down, and/or isolation.

Although particular features of an architecture have been described, other features may be incorporated to improve performance. For example, caching (e.g., L1, L2, . . . ) techniques may be used. Random access memory may be included, for example, to provide scratch pad memory and or to load executable code or parameter information stored for use during runtime operations. Other hardware and software may be provided to perform operations, such as network or other communications using one or more protocols, wireless (e.g., infrared) communications, stored operational energy and power supplies (e.g., batteries), switching and/or linear power supply circuits, software maintenance (e.g., self-test, upgrades), and the like. One or more communication interfaces may be provided in support of data storage and related operations.

Some systems may be implemented as a computer system that can be used with various implementations. For example, various implementations may include digital circuitry, analog circuitry, computer hardware, firmware, software, or combinations thereof. Apparatus can be implemented in a computer program product tangibly embodied in an information carrier, e.g., in a machine-readable storage device, for execution by a programmable processor; and methods can be performed by a programmable processor executing a program of instructions to perform functions of various embodiments by operating on input data and generating an output. Various embodiments can be implemented advantageously in one or more computer programs that are executable on a programmable system including at least one programmable processor coupled to receive data and instructions from, and to transmit data and instructions to, a data storage system, at least one input device, and/or at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, which may include a single processor or one of multiple processors of any kind of computer. Generally, a processor will receive instructions and data from a read-only memory or a random-access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including, by way of example, semiconductor memory devices, such as EPROM, EEPROM, and flash memory devices; magnetic disks, such as internal hard disks and removable disks; magneto-optical disks; and CD-ROM and DVD-ROM disks. The processor and the memory can be supplemented by, or incorporated in, ASICs (application-specific integrated circuits).

In some implementations, each system may be programmed with the same or similar information and/or initialized with substantially identical information stored in volatile and/or non-volatile memory. For example, one data interface may be configured to perform auto configuration, auto download, and/or auto update functions when coupled to an appropriate host device, such as a desktop computer or a server.

In some implementations, one or more user-interface features may be custom configured to perform specific functions. Various embodiments may be implemented in a computer system that includes a graphical user interface and/or an Internet browser. To provide for interaction with a user, some implementations may be implemented on a computer having a display device, such as a CRT (cathode ray tube) or LCD (liquid crystal display) monitor for displaying information to the user, a keyboard, and a pointing device, such as a mouse or a trackball by which the user can provide input to the computer.

In various implementations, the system may communicate using suitable communication methods, equipment, and techniques. For example, the system may communicate with compatible devices (e.g., devices capable of transferring data to and/or from the system) using point-to-point communication in which a message is transported directly from the source to the receiver over a dedicated physical link (e.g., fiber optic link, point-to-point wiring, daisy-chain). The components of the system may exchange information by any form or medium of analog or digital data communication, including packet-based messages on a communication network. Examples of communication networks include, e.g., a LAN (local area network), a WAN (wide area network), MAN (metropolitan area network), wireless and/or optical networks, the computers and networks forming the Internet, or some combination thereof. Other implementations may transport messages by broadcasting to all or substantially all devices that are coupled together by a communication network, for example, by using omni-directional radio frequency (RF) signals. Still other implementations may transport messages characterized by high directivity, such as RF signals transmitted using directional (i.e., narrow beam) antennas or infrared signals that may optionally be used with focusing optics. Still other implementations are possible using appropriate interfaces and protocols such as, by way of example and not intended to be limiting, USB 2.0, Firewire, ATA/IDE, RS-232, RS-422, RS-485, 802.11 a/b/g, Wi-Fi, Ethernet, IrDA, FDDI (fiber distributed data interface), token-ring networks, multiplexing techniques based on frequency, time, or code division, or some combination thereof. Some implementations may optionally incorporate features such as error checking and correction (ECC) for data integrity, or security measures, such as encryption (e.g., WEP) and password protection.

In various embodiments, the computer system may include Internet of Things (IoT) devices. IoT devices may include objects embedded with electronics, software, sensors, actuators, and network connectivity which enable these objects to collect and exchange data. IoT devices may be in-use with wired or wireless devices by sending data through an interface to another device. IoT devices may collect useful data and then autonomously flow the data between other devices.

Various examples of modules may be implemented using circuitry, including various electronic hardware. By way of example and not limitation, the hardware may include transistors, resistors, capacitors, switches, integrated circuits, other modules, or some combination thereof. In various examples, the modules may include analog logic, digital logic, discrete components, traces and/or memory circuits fabricated on a silicon substrate including various integrated circuits (e.g., FPGAS, ASICs), or some combination thereof. In some embodiments, the module(s) may involve execution of preprogrammed instructions, software executed by a processor, or some combination thereof. For example, various modules may involve both hardware and software.

In an illustrative aspect, a computer-implemented method may be performed by at least one processor to dynamically acquire inventory for a hospitality property. The method may include retrieve near future booking data (405) of a hospitality property. The method may include apply a first data model to identify historical future booking data (420) of the hospitality property, as a function of correlated attributes. The correlated attributes may include a season. The method may include apply a second data model to generate a predicted inventory usage as a function of the near future booking data and the historical future booking data (425). The method may include generate, by applying a third data model, a recommended inventory profile as a function of the predicted inventory usage (435). The method may include determine a stock inventory of the hospitality property (440). The method may include retrieve a supply availability data of the hospitality property (450). The supply availability data may include new inventory available from vendors. The supply availability data may include restored inventory of reusable inventory from process centers. The restoration process may include a restoration tracking process configured to compile the restored inventory in real-time. The method may include generate, by applying a fourth data model, a recommendation acquisition profile as a function of the supply availability data and the predicted inventory usage (455). The method may include generate an acquisition signal to acquire additional inventory (475) if the stock inventory is less than the recommended inventory profile, such that hospitality inventory of the hospitality property is automatically and dynamically managed in real-time, such that surplus inventory is automatically reduced.

The method may include retrieve environmental data corresponding to the near future booking data. The correlated attributes may include the environmental data. The correlated attributes may include booking attributes.

The method may include retrieve a property profile of the hospitality property. The recommended inventory profile may be generated as a function of the predicted inventory usage and the property profile.

Determining the stock inventory of the hospitality property may include determine spoilage rate of the stock inventory. Determining the stock inventory of the hospitality property may include apply the spoilage rates to a current inventory to generate the stock inventory.

The spoilage rates may be determined based on manufacturer recommendations. The spoilage rates may be determined by applying a machine learning model based on a historical reorder rate.

The method may include retrieve a property profile of the hospitality property. The recommended inventory profile may be generated as a function of the predicted inventory usage and the property profile. The spoilage rates may be determined as a function of manufacturer recommendations modified by the property profile.

The processing center may include a laundry service provider. The processing center may include a tableware cleaning provider.

The restoration tracking process may include determine a processing lead time of restoration at the process centers. The processing lead time may be generated based on a capacity information of the processing centers. The restoration tracking process may include generate a restoration processing order signal based on the recommendation acquisition profile.

Determine a stock inventory may include provide hardware configured to track movement of inventory in real-time. Determine a stock inventory may include determine the stock inventory based on the movement. The movement may include a quantity of inventory moving into and out of a designated area of the hospitality property.

The second data model may include a neural network model configured to perform iterative training operations to train the second data model. The iterative training operations may include retrieve a set of historical future booking data and a corresponding set subsequent historical inventory usage of the hospitality property. The iterative training operations may include apply the set of historical future booking data to the neural network model as training input data. The iterative training operations may include generate a predicted inventory usage corresponding to the set historical future booking data, using the neural network model, as training output data. The iterative training operations may include generate a comparison result as a function of the training output data and the training output data. The iterative training operations may include update the neural network model as a function of the comparison result. The iterative training operations may include repeat the iterative training operations until the comparison result is within a predetermined accuracy threshold of the corresponding set subsequent historical inventory usage.

The hospitality property may include a hotel. The hospitality property may include a hospital. The hospitality property may include a restaurant.

In an illustrative aspect, a computer program product (CPP) may include a program of instructions tangibly embodied on a non-transitory computer readable medium. When the instructions are executed on a processor, the processor may cause operations to be performed to dynamically manage inventory of a hospitality property. The operations may include one or more operations discloses with respect to the computer-implemented method(s) described above.

In an illustrative aspect, a system may include a data store including a program of instructions. The system may include a processor(s) (e.g., one or more processors) operably coupled to the data store such that, when the processor executes the program of instructions, the processor causes operations to be performed. The operations may, for example, be performed to dynamically manage inventory of a hospitality property. The operations may, for example, include one or more operations discloses with respect to the computer-implemented method(s) described above.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

1. A computer program product (CPP) comprising a program of instructions tangibly embodied on a non-transitory computer readable medium wherein, when the instructions are executed on a processor, the processor causes operations to be performed to dynamically acquire inventory for a hospitality property, the operations comprising:
retrieve near future booking data (405) of a hospitality property;
apply a first data model to identify historical future booking data (420) of the hospitality property as a function of correlated attributes, wherein the correlated attributes comprise a season;
apply a second data model to generate a predicted inventory usage as a function of the near future booking data and the historical future booking data (425);
generate, by applying a third data model, a recommended inventory profile as a function of the predicted inventory usage (435);
determine a stock inventory of the hospitality property (440) based on a signal representing a movement of inventory received from at least one movement tracking device;
retrieve a supply availability data of the hospitality property (450), wherein the supply availability data comprises:
new inventory available from vendors, and,
restored inventory of reusable inventory from a restoration process at processing centers, wherein the restoration process comprises a restoration tracking process configured to compile the restored inventory in real-time;
generate, by applying a fourth data model, a recommendation acquisition profile as a function of the supply availability data and the predicted inventory usage (455); and,
generate an acquisition signal to acquire additional inventory (475) if the stock inventory is less than the recommended inventory profile, such that hospitality inventory of the hospitality property is automatically and dynamically managed in real-time, and wherein
the second data model comprises a machine learning model configured to iteratively train the second data model from time to time, such that, in response to a test data comprising a set of historical near future booking data, a predicted inventory usage corresponding to the test data is within a predetermined accuracy threshold, such that surplus inventory is automatically reduced.

2. The CPP of claim 1, wherein the operations further comprise:
retrieve environmental data corresponding to the near future booking data,
wherein the correlated attributes further comprise the environmental data.

3. The CPP of claim 1, wherein the correlated attributes further comprise booking attributes.

4. The CPP of claim 1, wherein the operations further comprise:
retrieve a property profile of the hospitality property,
wherein the recommended inventory profile is generated as a function of the predicted inventory usage and the property profile.

5. The CPP of claim 1, wherein determining the stock inventory of the hospitality property comprises:
determine spoilage rate of the stock inventory; and,
apply the spoilage rates to a current inventory to generate the stock inventory.

6. The CPP of claim 5, wherein the spoilage rates are determined based on manufacturer recommendations.

7. The CPP of claim 5, wherein the spoilage rates are determined by applying a machine learning model based at least on a historical reorder rate.

8. The CPP of claim 5, wherein the operations further comprise:
retrieve a property profile of the hospitality property, wherein the recommended inventory profile is generated as a function of the predicted inventory usage and the property profile, and,
the spoilage rates are determined as a function of manufacturer recommendations modified by the property profile.

9. The CPP of claim 1, wherein the processing center comprises a laundry service provider.

10. The CPP of claim 1, wherein the processing center comprises a tableware cleaning provider.

11. The CPP of claim 1, wherein the restoration tracking process further comprises:
determine a processing lead time of restoration at the processing centers, wherein the processing lead time is generated based on a capacity information of the processing centers; and,
generate a restoration processing order signal based on the recommendation acquisition profile.

12. The CPP of claim 1, wherein the movement of inventory is received in real-time and comprises a quantity of inventory moving into and out of a designated area of the hospitality property.

13. The CPP of claim 1, wherein the machine learning model comprises a neural network model.

14. The CPP of claim 1, wherein the hospitality property comprises a hotel.

15. The CPP of claim 1, wherein the hospitality property comprises a hospital.

16. The CPP of claim 1, wherein the hospitality property comprises a restaurant.

17. A computer-implemented method performed by at least one processor to dynamically acquire inventory for a hospitality property, the method comprising:
retrieve near future booking data (405) of a hospitality property;
apply a first data model to identify historical future booking data (420) of the hospitality property; as a function of correlated attributes, wherein the correlated attributes comprise a season;
apply a second data model to generate a predicted inventory usage as a function of the near future booking data and the historical future booking data (425);
generate, by applying a third data model, a recommended inventory profile as a function of the predicted inventory usage (435);
determine a stock inventory of the hospitality property (440) based on a signal representing a movement of inventory received from at least one movement tracking device;
retrieve a supply availability data of the hospitality property (450), wherein the supply availability data comprises:
new inventory available from vendors; and,
restored inventory of reusable inventory from a restoration process at processing centers, wherein the restoration process comprises a restoration tracking process configured to compile the restored inventory in real-time;
generate, by applying a fourth data model, a recommendation acquisition profile as a function of the supply availability data and the predicted inventory usage (455); and,
generate an acquisition signal to acquire additional inventory (475) if the stock inventory is less than the recommended inventory profile, such that hospitality inventory of the hospitality property is automatically and dynamically managed in real-time, such that surplus inventory is automatically reduced.

18. The computer-implemented method of claim 17, further comprising:
retrieve environmental data corresponding to the near future booking data,
wherein the correlated attributes further comprise the environmental data.

19. The computer-implemented method of claim 17, wherein the correlated attributes further comprise booking attributes.

20. The computer-implemented method of claim 17, further comprising:
retrieve a property profile of the hospitality property,
wherein the recommended inventory profile is generated as a function of the predicted inventory usage and the property profile.

21. The computer-implemented method of claim 17, wherein determining the stock inventory of the hospitality property comprises:
determine spoilage rate of the stock inventory; and,
apply the spoilage rates to a current inventory to generate the stock inventory.

22. The computer-implemented method of claim 21, wherein the spoilage rates are determined based on manufacturer recommendations.

23. The computer-implemented method of claim 21, wherein the spoilage rates are determined by applying a machine learning model based on historical reorder rate.

24. The computer-implemented method of claim 21, further comprising:
retrieve a property profile of the hospitality property,
wherein:
the recommended inventory profile is generated as a function of the predicted inventory usage and the property profile, and,
the spoilage rates are determined as a function of manufacturer recommendations modified by the property profile.

25. The computer-implemented method of claim 17, wherein the processing center comprises a laundry service provider.

26. The computer-implemented method of claim 17, wherein the processing center comprises a tableware cleaning provider.

27. The computer-implemented method of claim 17, wherein the restoration tracking process further comprises:
determine a processing lead time of restoration at the processing centers, wherein the processing lead time is generated based on a capacity information of the processing centers; and,
generate a restoration processing order signal based on the recommendation acquisition profile.

28. The computer-implemented method of claim 17, wherein the movement of inventory is received in real-time and comprises a quantity of inventory moving into and out of a designated area of the hospitality property.

29. The computer-implemented method of claim 17, wherein the second data model comprises a neural network model configured to perform iterative training operations to train the second data model, wherein the iterative training operations comprises:
retrieve a set of historical future booking data and a corresponding set subsequent historical inventory usage of the hospitality property;
apply the set of historical future booking data to the neural network model as training input data;
generate a predicted inventory usage corresponding to the set historical future booking data, using the neural network model, as training output data;
generate a comparison result as a function of the training output data and the training output data;
update the neural network model as a function of the comparison result; and,
repeat the iterative training operations until the comparison result is within a predetermined accuracy threshold of the corresponding set subsequent historical inventory usage.

30. The computer-implemented method of claim 17, wherein the hospitality property comprises a hotel.

31. The computer-implemented method of claim 17, wherein the hospitality property comprises a hospital.

32. The computer-implemented method of claim 17, wherein the hospitality property comprises a restaurant.

33. The CPP of claim 1, wherein the acquisition signal is generated based on the recommended acquisition profile.

34. The CPP of claim 1, wherein the operations further comprise: generate a recommended acquisition display based on the recommended acquisition profile.

35. The method of claim 17, wherein the acquisition signal is generated based on the recommended acquisition profile.

36. The method of claim 17, wherein the operations further comprise: generate a recommended acquisition display based on the recommended acquisition profile.

37. The CPP of claim 1, wherein the movement tracking device comprises a physical identifier of inventory, the physical identifier monitored by at least one networked device.

38. The CPP of claim 37, wherein the physical identifier comprises an RFID tag.

39. The method of claim 17, wherein the movement tracking device comprises a physical identifier of inventory, the physical identifier monitored by at least one networked device.

40. The method of claim 39, wherein the physical identifier comprises an RFID tag.
